(19) United States
(12) Patent Application Publication
(10) Pub. No.: US 2004/0260210 A1
(43) Pub. Date: Dec. 23, 2004

(54) System and method for face and body treatment

(75) Inventors: Sima Ella, Tel Aviv (IL); Haim Rave, Tikya (IL)

Correspondence Address: G.E. EHRLICH (1995) LTD., c/o ANTHONY CASTORINA, SUITE 207, 2001 JEFFERSON DAVIS HIGHWAY, ARLINGTON, VA, 22202, US

(73) Assignee: Engii (2001) Ltd.

(21) Appl. No.: 10/763,230

(22) Filed: Jan. 26, 2004

Related U.S. Application Data
(63) Continuation-in-part of application No. 10/600,836, filed on Jun. 23, 2003.

(51) Int. Cl. A61H 15/02; A61H 23/02

(52) U.S. Cl. 601/7; 601/15; 601/10

(57) ABSTRACT

Arrangements and packaging of multi-device, face-and-body-treatment systems are presented, for adapting these systems to self-application and to home use. In particular, a multi-device, face-and-body-treatment laptop-like kit is described, for beauty treatment “on the go.” Additionally, a multi-device, face-and-body-treatment system built into a dresser is taught, for beauty treatment in the home. Other arrangements are also described.

### CROSS-REFERENCE TO RELATED APPLICATIONS

This is a Continuation-In-Part of pending U.S. patent application Ser. No. 10/600,836, filed on Jun. 23, 2003, which claims priority from pending U.S. patent application Ser. No. 10/350,222, filed on Jan. 24, 2003, which claims priority from PCT/IL02/00658, filed on Aug. 8, 2002, which claims priority from abandoned U.S. patent application No. 10/144,983, filed on May 15, 2002, from U.S. Provisional Patent Application No. 60/349,984, filed on Jan. 23, 2002, and from U.S. Provisional Patent Application No. 60/310,479, filed on Aug. 8, 2001.

### FIELD AND BACKGROUND OF THE INVENTION

The present invention relates generally to face-and-body-treatment systems, and in particular, to arrangements and packaging of multi-device, face-and-body-treatment systems for self-application and for home use.

A large assortment of face-and-body-treatment devices is available today. These devices are aimed at cleansing, skin rejuvenation, cellulite breakdown, anti-ageing, stretch-mark removal, wrinkle removal, include-pain relief, hair setting, makeup application, and the like, and include, for example, suction, macro massage treatment, cupping treatment, warming light treatment, infrared light treatment, UV light treatment, Low Level Laser Treatment (LLLT), ultrasound treatment, pulsating magnetic field treatment, constant magnetic field treatment, electrostimulation treatment, cooling-diode treatment, warming diode treatment, mechanical epilation, photoepilation, hair drying, electric hair setting, rotating-hair-brush hair rolling, nail drying, oxygen treatment, ozone treatment, steam treatment, sandblasting peeling, face-and-body-cleaning-moisturizing-and-massaging treatment, lymphatic massage treatment, and many others.

Yet, in general, it would be impractical for an average person to own more than one or two of these devices, not only because of the associated costs, but also because of space requirements. Therefore, most of the above mentioned treatments are available in clinics, where they are relatively expensive.

Massage devices, which employ suction, are known. Generally, they include a structural casing, which defines a vacuum chamber with an open lower surface, and suction means. The casing is adapted for gliding along a portion of the body. Utilizing a partial vacuum, they cause a lifting of the skin, to form a skin fold. As the device is moved across the body, the skin fold is rolled over by the casing. Thus the device imitates and automates a conventional massaging method, known as “palpate and roll”, which stimulates blood circulation.

Inner rollers may be arranged within the casing so as to press against the skin folds. These may be associated with motorized drives, for a pinching-like effect, or may rotate freely with the movement of the device.

Massage devices, which employ suction, are described, for example, in U.S. Pat. No. 6,200,281, to Frajdenrajch, entitled, “Massaging device which is designed to be applied to the skin of a person,” U.S. Pat. No. 6,090,055, to Frajdenrajch, entitled, “Massaging Device,” U.S. Pat. No. 6,017,320 to Bleeker, et al., entitled, “Massaging apparatus having two rollers and a suction chamber,” U.S. Pat. No. 5,897,512 to Zagame, entitled, “Massage appliance for moving over a predetermined zone of the human body,” U.S. Pat. No. 3,841,323 to Dan, entitled “Massage Apparatus,” and U.S. Pat. No. 6,196,982, to Ball, entitled, “Vacuum massager, ” whose disclosures are incorporated herein by reference.

Additionally, U.S. Pat. No. 5,961,475, entitled, “Massage apparatus with sucking and mobilising action on skin tissue,” and U.S. Pat. No. 5,885,232, entitled, “Roller massaging apparatus with suction fucntion” both to Guitay, both assigned to LPG Systems of France, and both incorporated herein by reference, describe vacuum massage systems, generally for spas and health centers.

U.S. Pat. No. 4,748,973, to Cho, entitled, “Pneumatic Massage Device,” whose disclosure is incorporated herein by reference, describes a pneumatic massage device, adapted for self-application, without the assistance of another person.

Both U.S. Pat. No. 3,906,940, to Kawada, entitled “Facial Treatment Device,” and U.S. Pat. No. 5,003,966, to Saka, et al., entitled, “Suction device,” whose disclosures are incorporated herein by reference, describe vacuum and massage devices that are adapted for facial treatment.

Another known form of face and body treatment is light treatment, and more specifically, low laser light treatment (LLLT). LLLT refers to laser light at an output of between 1 and 500 Mw. These values are not strong enough to damage chemical bonds in the tissue, but do cause a photochemical effect LLLT is also referred to as “cold laser” or “soft laser.”

According to “The Healing Nature of light,” http://www.laserpath.com/lpwhatisllt.htm, 1998-2001 LaserPath Therapeutics, downloaded on Apr. 23, 2002, the physiological effects of LLLT include biostimulation, improved metabolism, increase cell metabolism, improved blood circulation and vasodilatation, an analgesic effect, anti-inflammatory and anti-edematous effects, and stimulation of wound healing.

Similarly, according to “Laser Treatment, http://www.skylarkdevice.com/english/laser_e.htm, 2000-2001 Skylark Inc., and according to LLLT, http://www.medsolution.de/LLLT.htm, both downloaded on Apr. 23, 2002, LLLT promotes the production of collagen and the synthesis of protein, accelerates blood circulation, increases lymphatic flow, excites cell division, improves immunity, revives white corpuscles, stimulates the synthesis of Adenosin Tri Phosphate (ATT), and increases the synthetic energy of nucleic acid. Additionally, LLLT can stimulate the skin to improve its tension and elasticity, reduce wrinkles, remove scars, and slow down skin aging.

LLLT penetrates the body to a depth of between 3-5 cm, depending on its wavelength. Light waves in the near infrared ranges penetrate the deepest of all light wave in the visible spectrum.

The recommended wavelength for biostimulation is in the range between 630 and 1200 nm.

U.S. Pat. No. 4,930,504 to Diamantopoulos, et al. entitled, “Device for biostimulation of tissue and method for treatment of tissue,” whose disclosure is incorporated herein by reference, describes a system and method for stimulation of skin and it underlying tissue by laser light of various wavelengths, preferably of at least three different wavelengths. The radiation sources are arranged within the array such that radiation of at least two different wavelengths passes directly or indirectly through a single point located within the treated tissue. The radiation sources are preferably laser diodes, super luminous diodes or similar light-knitting diodes that, while low-power radiation sources, can provide significant energy densities to a treatment area. A method of treatment of tissue comprising exposing the treated tissue to the above-described device is also disclosed. The device for biostimulation of tissue may be included within a system with a control panel, a power source, variable pulse frequency, variable pulse duration, a timer for timing the period of treatment, a device for measuring the conductivity of the treated tissue, a device for measuring the optical power emitted by the radiation sources and (or) a device for detecting emissions from the radiation sources. When three different wavelengths are used, the first wavelength is selected from the group consisting of 650 nm, 660 nm, 680 nm, 750 nm, 780 nm, 800 nm, 810 nm and 820 nm; the second wavelength is selected from the group consisting of 830 nm, 840 nm, 850 nm, 860 nm, 870 nm, and 880 nm; and the third wavelength is selected from the group consisting of 900 nm, 904 nm, 950 nm, 1100 nm, 1300 nm and 1500 nm.

U.S. Pat. No. 5,445,146, to Bellinger, entitled, Biological tissue stimulation by low level optical energy,” whose disclosure is incorporated herein by reference, describes a method of irradiating a biological tissue of a living subject with optical energy. The wavelength and power dissipation level are such as to cause the amount of optical energy absorbed and converted to heat in the tissue to be within a range bounded by a minimum absorption rate sufficient to elevate the average temperature of the irradiated tissue to a level above the basal body temperature, but which is less than the absorption rate at which tissue is converted into a collagenous substance. According to this method, a therapeutic, warming effect is produced within the irradiated tissue, but without causing tissue damage by thermal overheating. The method of using a low level reactive laser system from 100 milliwatts to 800 milliwatts in either a pulsed or continuous mode with optical energy produced by a Nd:YAG laser at a fundamental wavelength of 1064 nanometers has been found to reduce pain in soft tissues, reduce inflammation and enhance the healing of tissue by stimulation of microcirculation without subjecting the living tissue to damaging thermal effects. The energy density of the irradiated tissue is limited to the range of from about 1 joule per square centimeter to about 15 joules per square centimeter.

Light treatment at other wavelengths is also known. For example, U.S. Pat. No. 4,558,700, to Mutzhas, entitled, “UV Radiation device for phototreatment of dermatoses, especially psoriasis,” whose disclosure is incorporated herein by reference, describes a UV radiation device for phototreatment of dermatoses, especially psoriasis. The device produces UV radiation at a wavelength range below 300 nm at a first intensity, and radiation at a wavelength range between 300 and 310 nm, at a second intensity, substantially higher than the first intensity. She radiation dose being between 0.7 and 1.0 times the erythema threshold dose. Such a UV radiation device is distinguished by good therapeutic effectiveness and the avoidance of undesirable side effects. The power delivered to thc skin using Mutzhas' lamp is described as 150 W/m², which does not have a significant effect on skin temperature.

Similarly, U.S. Pat. No. 4,354,139, to Konijnendijk, et al., entitled, “Low-pressure mercury vapor discharge lamp,” whose disclosure is incorporated herein by reference, describes a low-pressure mercury vapor discharge lamp for radiation purposes. The lamp has a discharge tube made of glass with selective transmission, the tube being coated on the inside with a luminescent layer. This layer contains a luminescent material, which has the characteristic line emission of gadolinium at 312 nm. The discharge tube is made of glass having an absorption edge located between 260 and 280 fin and the tube has at 312 nm a transmission of at least 80%. It is known that radiation in the wavelength range from 305-320 nm may have a favorable therapeutic effect, for example in the treatment of psoriasis and other skin diseases.

U.S. Pat. No. 5,755,751, to Eckhouse, entitled, “Method and apparatus for therapeutic electromagnetic treatment,” whose disclosure is incorporated herein by reference, describes a therapeutic treatment method includes the steps of providing a pulsed incoherent light output for treatment, directing the pulsed light output to a treatment area, transmitting the pulsed light output through the epidermis at the treatment area, heating the epidermis to a temperate below the temperature at which the epidermis is damaged and coagulating blood in blood vessels disposed below the epidermis.

According to U.S. Pat. No. 5,755,751, hereinabove, when treating vascular disorder, blood content affects the absorption coefficient of the treatment area. Oxyhemoglobin is the main chromophore, which controls the optical properties of blood and has strong absorption bands in the visible region. More particularly, the strongest absorption peak of oxyhemoglobin occurs at 418 nm and has a band-width of 60 nm. Two additional absorption peaks with lower absorption coefficients occur at 542 and 577 nm. The total band-width of these two peaks is on the order of 100 nm.

Additionally, light in the wavelength range of 500 to 600 nm is desirable for the treatment of blood vessel disorders of the skin since it is absorbed by the blood and penetrates through the skin. Longer wavelengths up to 1000 nm are also effective since they can penetrate deeper into the skin, heat the surrounding tissue and, if the pulse-width is long enough, contribute to heating the blood vessel by thermal conductivity. Also, longer wavelengths are effective for treatment of larger diameter vessels because the lower absorption coefficient is compensated for by the longer path of light in the vessel.

Accordingly, a wide band electromagnetic radiation source that covers the near UV and the visible portion of the spectrum would he desirable for treatment of external skin and vascular disorders. The overall range of wavelengths of the light source should be sufficient to optimize treatment for any of a number of applications. Such a therapeutic electromagnetic radiation device should also be capable of providing an optimal wavelength range within the overall range for the specific disorder being treated. The intensity of the light should be sufficient to cause the desired thermal effect by raising the temperature of the treatment area to the required temperature. When using pulsed light, the pulse-width should be variable over a wide enough range so as to achieve the optimal penetration depth for each application. Therefore, it is desirable to provide a light source having a wide range of wavelengths, which can be selected according to the desired skin treatment, with a controlled power output and a controlled pulse-width for a particular skin application.

Another known form of face and body treatment is ultrasound treatment. According to “Ultrasound Treatment,” Skylark Inc., http://www.skylarkdevice.com/english/ultrasonic_e.htm#head, ultrasound refers to acoustic waves over 20000 Hz, and in general, ultrasound devices for medical and beauty treatment range in frequency from 1 to 5 MHz. A safe standard for a continuous waveform ultrasound is about 1 W/cm², for about 15 minutes, for general muscle treatment. For facial treatment, it is about 0.5 W/cm², for about 10 minutes. A safe standard for a pulse waveform is about 240 mW/cm². By comparison, shattering kidney stones requires about 10 W/cm². The transmission of ultrasound in air is very low, and generally, an interface of a special gel needs to be used between the ultrasound transducer and the skin.

Ultrasound causes a massaging or vibrating action, which may be regarded as a micro-massaging action. A consequence of it is a heating action. Massaging with 1 MHz for ten minutes may cause a temperature increase of 0.5-1° C., at a tissue depth of 4-5 cm. The warming effect increases blood circulation and tissue metabolism. Ultrasound also causes cavitation of the interface material, which leads to a cleansing of the skin. Additionally, ultrasound increases skin absorption of external matter.

Skylark Incorporated (12th FL., 34, Sec. 3, Chuang Shan N. Rd., Taipei, 104, Taiwan Tel: 886-2-25979005 Fax. 886-2-25912344), carries several products for ultrasound treatment. For example, Ultrasound Treatment Unit (1 MHz) SD-957 is a lightweight device that operates at 1 MHz. It is used for treating deep textures, 2-4 cm into the skin, for example, in regions of the leg, the hip, the back, and the like. Ultrasound Beauty SD-958, a beauty/skin care device, operating at 3 MHz, is specifically adapted for facial treatment.

U.S. Pat. No. 6,325,769, to Klopotek, entitled, “Method and apparatus for therapeutic treatment of skin,” whose disclosure is incorporated herein by reference, describes a method and apparatus which use ultrasound for a therapeutic treatment. According to Klopotek, controlled application of ultrasound energy into the dermis layer reduces the extent of wrinkles and rejuvenate the skin. The ultrasound energy triggers a biological response that causes synthesis of new connective tissue in the dermis through activation of fibroblast cells in the dermis without causing or requiring a significant irritation or damage to the epidermis. One purpose of the present method is to provide a cosmetic improvement in the appearance of the skin, meaning that the treated skin surface will have a smoother, rejuvenated appearance, without the need to induce a significant damage to the epidermis layer of the skin.

U.S. Pat. No. 5,665,053 to Jacobs, entitled “Apparatus for performing endermology with ultrasound,” whose disclosure is incorporated herein by reference, describes an endermology body massager having at least two rollers spaced from each other in a parallel configuration. The rollers rotate in the same direction and are mounted on movable axes. A vacuum source is connected to the chamber that houses the rollers. The vacuum source facilitates the suction of the skin between the rollers and helps bring the rollers closer to each other during operation. The rollers or housing have ultrasound generators that are selectively controlled by the operator. In a first embodiment, the ultrasound generators are located within the rollers. In the second embodiment, the ultrasound generators are disposed in the housing around the rollers. Therefore, a controlled and combined endermology with ultrasound treatment can be achieved.

Another known form of face and body treatment is magnetic treatment. According to “Magnetic and electromagnetic treatment,” By David Ramey, www.here.organism/conntriib/ramey/magnet/html, Health Care Reality Check, downloaded on Nov. 20, 2001, researchers believe that a pulsating magnetic field may stimulate biological processes, pertinent for example, to osteogenesis, healing of chronic wounds, and neuronal regeneration.

U.S. Pat. No. 5,669,868, to Markoll, “Treatment of wrinkled discolored or aging skin with magnetic field treatment,” whose disclosure is incorporated herein by reference, describes a process for treating skin by subjecting it to magnetic treatment by an annular coil energized by pulsed D.C. voltage having a rectangular wave form pulsing at the rate of 1-30 CPS, the coil producing a field of under 20 gauss.

Another mode of treatment is epilation, or hair removal. Various manners of epilation are known. For example, the Epilady is a mechanical hair removal device described in http://www.epiladyusa.com, as well as in U.S. Pat. No. 6,277,129, to Poran, entitled “Dual ended hair remover,” whose disclosure is incorporated herein by reference. The Epiladay has a series of high velocity rotating discs, operating like tweezers, that remove hair by the root. Several designs are available, for example, Discrete, and Discrete Plus, both having two sees, and generally adapted for women's legs, and Lady Bikini, a sensitive trimmer for intimate ars.

Laser based photoepilation is also known. Optical pulses of an appropriate wavelength, pulse duration, and energy density, impinging upon human skin, will result in significant and enduring hair loss. The accepted theory for this phenomenon is that the penetration of the laser into the skin and its subsequent scattering result in heating of the hair shafts and follicles through selective absorption by melanin. The absorption leads to heating of the follicle and subsequent thermal necrosis.

It has been found that for effective photoepilation, the energy must penetrate approximately 3 mm into the tissue. Prevailing thought indicates that this means the absorption should occur in the melanin. Based on the absorption spectrum of melanin, wavelengths in the neighborhood of 700 nm are thought to be efficacious.

U.S. Pat. No. 6,273,885, to Koop, et al., entitled, “Handheld photoepilation device and method,” whose disclosure is incorporated herein by reference, describes a handheld laser tissue treatment device for hair removal. The device comprises a semiconductor diode or diode array laser which emit energy and a device for surface cooling of tissue such that the energy is directed through the cooling device in contact with tissue. The diode laser operates at wavelengths between about 630 mm and 980 nm, and delivers a predetermined amount of energy in a predetermined period of time. Additionally, it has a predetermined spot size. The device utilizes one or more microlenses or microlens arrays to collimate the diode laser energy. Optionally, the device utilizes a deflecting optic for deflecting the diode laser energy through the cooling device which is in contact with tissue in which the deflecting optic is visually transparent such that the operator can see the tissue treatment area. A cooling device such as a sapphire plate or other active or passive cooling means is used to cool the tissue. A method for treatment of tissue, including hair removal, with a handheld device comprises generating laser energy from a semiconductor diode laser, directing the energy through a cooling device in contact with tissue, and treating tissue with the laser energy.

SpaTouch hair removal system, a description of which may be found in http://198.174.40.227/new/radiancy/radiancy, as well as in U.S. Pat. No. 6,214,034, to Azar, entitled, “Method of selective photothermolysis,” and U.S. Pat. No. 6,187,001, to Azar, et al., entitled, “Apparatus and method for removing hair,” whose disclosure are incorporated herein by reference, works on the principle of selective photothermolysis common to other high-tech laser and light-based devices. However, rather than laser, it utilizes pulsed light (in durations of 35 milliseconds) in a wavelength range favorable to melanin, over a very large spot size, for example, about 22×55 mm.

Each of the aforementioned treatment system has specific advantages. A person wishing to benefit from these would have to attend a treatment clinic offering a wide choice of treatment devices, or acquire many different devices, suffering the associated expense and space requirements.

Systems that will make these devices more accessible are desired.

### SUMMARY OF THE INVENTION

According to one aspect of the present invention, there is provided a face-and-body-treatment system, comprising:

a computerized device, for operating the system, the computerized device including:

at least one electrical control feature, for controlling the operation of the system;

a display screw, for displaying parameters relating to the treatment; and

a controller, in signal communication with the display scam and the at least one electrical control feature; and

a mirror, integrated with the system, for self-application of face-and-body treatments; and

at least one treatment device.

Additionally, the system includes a timing device.

Additionally, the display screen is interactive.

Additionally, the at least one electrical control feature includes a plurality of electrical control features.

Additionally, the system is adapted for storing desired operational schedules in a memory.

Additionally, the system is adapted for reading desired operational schedules from a memory.

Additionally, the system is adapted for maintaining a treatment schedule log, for follow-up of treatment application types, durations, operational parameters and dates and hours of the applications.

Additionally, the system is adapted for maintaining a treatment schedule log, for follow-up of treatment application types, durations, operational parameters, and dates and hours of the applications, for several users, by user ID.

Additionally, the at least one treatment device is a suction treatment device, in signal communication with the controller and in fluid communication with a vacuum source, the device having a spout, which defines an inner chamber, and the device being adapted to apply a suction treatment to a portion of the body.

Alternatively, the vacuum source is a central vacuum line.

Additionally, the vacuum source is a dedicated pump.

Alternatively, the vacuum source is a vacuum cleanser.

Additionally, the vacuum source is in signal communication with the controller and the vacuum source is adapted to operate at different levels of suction, as controlled by the controller and as selected via the at least one electrical control feature.

Additionally, the vacuum source is in signal communication with the controller and the vacuum source is adapted to pulsate at different frequencies, as controlled by the controller and as selected via the at least one electrical control feature.

Additionally, the suction treatment device is selected from the group consisting of a device generally for the face, a device for the area around the eyes, a device for the chin, a device for the general body, a device for the breast, a device for the two breasts, and a device for the penis.

Additionally, the spout comprises a roller.

Additionally, the spout is adapted to glide along a portion of the body and apply suction, macro massage treatment thereto.

Additionally, the spout comprises a second mode of treatment, selected from the group consisting of warming light treatment, white-light halogen treatment, far infrared light treatment, medium infrared light treatment, near infrared light treatment, UV light treatment, Low Level Laser Treatment (LLLT), RF treatment, ultrasound treatment, pulsating magnetic field treatment, constant magnetic field treatment, electrostimulation treatment, cooling-diode treatment, warming-diode treatment, mechanical epilation, photoepilation, cupping treatment, hair drying, nail drying, oxygen treatment, ozone treatment, and steam treatment.

Additionally, the system is adapted for automatically applying a desired operational schedule of the suction massage treatment and the second mode of treatment, each treatment having predetermined operational parameters.

Additionally, the system is adapted for automatically applying the desired operational schedule, in a manner selected from the group consisting of in parallel and in series.

Additionally, the spout comprises at least two additional modes of treatment, selected from the group consisting of warming light treatment, white-light halogen treatment, far infrared light treatment, medium infrared light treatment, near infrared light treatment, UV light treatment, Low Level Laser Treatment (LLLT), RF treatment, ultrasound treatment, pulsating magnetic field treatment, constant magnetic field treatment, electrostimulation treatment, cooling-diode treatment, warming-diode treatment, mechanical epilation, photoepilation, cupping treatment, hair drying, nail drying, oxygen treatment, ozone treatment, and stream treatment.

Additionally, the system is adapted for automatically applying a desired operational schedule of the suction massage treatment and the at least two additional modes of treatment, each treatment having predetermined operational parameters.

Additionally, the system is adapted for automatically applying the desired operational schedule, in a manner selected from the group consisting of in parallel and in series.

Additionally, the at least one treatment device comprises a plurality of treatment devices, of different shapes and features.

Additionally, the plurality of treatment devices are detachable and interchangeable.

Additionally, the plurality of treatment devices are adapted for women.

Alternatively, the plurality of treatment devices are adapted for men.

Alternatively, the plurality of treatment devices are adapted for both men and women.

Additionally, the plurality of treatment devices are adapted for a clinic.

Additionally, the at least one treatment device is adapted for at least two modes of treatment.

Additionally, the system is adapted for automatically applying a desired operational schedule of the two modes of treatment, each treatment having predetermined operational parameters.

Additionally, the system is adapted for automatically applying the desired operational schedule, in a manner selected from the group consisting of in parallel and in series.

Additionally, the at least one treatment device is adapted for applying a mode of treatment, selected from the group consisting of suction treatment, suction, macro massage treatment, cupping treatment, warming light treatment, white-light halogen treatment, white-light fluorescent treatment, far infrared light treatment, medium infrared light treatment, near infrared light treatment, UV light treatment Low Level Laser Treatment (LLLT), RF treatment, ultrasound treatment, pulsating magnetic field treatment, constant magnetic field treatment, electrostimulation treatment, microcurrent treatment, cooling-diode treatment, warming-diode treatment, mechanical epilation, photoepilation, ultrasound epilation, hair drying, electric hair setting, rotating-hair-brush hair rolling, nail drying, oxygen treatment, oxygen peeling, ozone treatment, steam treatment, sandblasting peeling, face-and-body-cleaning-moisturizing-and-massaging treatment, lymphatic massage treatment, and air-brush makeup application.

Additionally, the at least one treatment device is adapted for applying at least two different modes of treatment, selected from the group consisting of suction treatment, suction, macro massage treatment, cupping treatment, warming light treatment, white-light halogen treatment, white-light fluorescent treatment, far infrared light treatment, medium infrared light treatment, near infrared light treatment, UV light treatment, Low Level Laser Treatment (LLLT), RF treatment, ultrasound treatment, pulsating magnetic field treatment, constant magnetic field treatment, electrostimulation treatment, microcurrent treatment, cooling-diode treatment, warming-diode treatment, mechanical epilation, photoepilation, ultrasound epilation, hair drying, electric hair setting, rotating-hair-brush hair rolling, nail drying, oxygen treatment, oxygen peeling, ozone treatment, steam treatment, sandblasting peeling, face-and-body-cleaning-moisturizing-and-massaging treatment, lymphatic massage treatment, and air-brush makeup application.

Additionally, the system is arranged as a portable system.

Additionally, the system is arranged as a face-and-body-treatment laptop, wherein:

the mirror is built into a cover of the laptop;

the computerized system is built into the laptop; and

the at least one treatment device is stored within an inner space of the laptop.

Additionally, the system includes a power source.

Additionally, the power source is rechargeable.

Additionally, the system includes a control panel, for the at least one electrical control feature and the display screen.

Additionally, the system includes a vacuum pump.

Additionally, the at least one treatment device is a suction treatment device, having a suction hose, coiled in a duct within the inner space, and sized so as to exactly fit within the duct.

Additionally, the system includes a compressor.

Additionally, the at least one treatment device comprises at least two treatment devices, stored within an inner space of the laptop.

Additionally, the mirror includes a lighting system.

Additionally, the mirror includes a magnification portion.

Additionally, the system includes a magnification lens, attached to the mirror.

Additionally, the mirror includes flaps, for viewing from a side angle.

Additionally, the flaps are adjustable for different viewing angles.

Additionally, the mirror is removable and detachable, for viewing from different positions and angles.

Additionally, the display panel is arranged on the mirror.

Additionally, the control panel is arranged along the mirror.

Additionally, the system is arranged in a carrying trunk, and further including a pump, arranged within the carrying trunk.

Additionally, the system includes a compressor, arranged within the carrying trunk.

Alternatively, the system is built into a dresser.

Additionally, the system includes a control panel, for the at least one electrical control feature and the display scam.

Additionally, the system includes a power source.

Additionally, the system includes a vacuum pump.

Additionally, the system includes a compressor.

Additionally, the system includes at least one treatment devices comprises at least two treatment devices, stored within an inner space of the laptop.

Additionally, the mirror includes a lighting system.

Additionally, the mirror includes a magnification portion.

Additionally, wherein the system includes a magnification lens, attached to the mirror.

Additionally, the mirror includes flaps, for viewing from a side angle.

Additionally, the flaps are adjustable for different viewing angles.

Additionally, the mirror is removable and detachable, for viewing from different positions and angles.

Additionally, the display panel is arranged on the mirror.

Additionally, the control panel is arranged along the mirror.

Alternatively, the system is built into a chair.

Additionally, the system includes a control panel, for the at least one electrical control feature and the display screen.

Additionally, the system includes a power source.

Additionally, the system includes a vacuum pump.

Additionally, the system includes a compressor.

Alternatively, the system is built into a room.

Additionally, the system includes a control panel, for the at least one electrical control feature and the display screen.

Additionally, the system includes a pump.

Additionally, the system includes a compressor.

Additionally, the room is a bedroom.

Additionally, the room is a bathroom.

Additionally, the room is a clinic.

According to one aspect of the present invention, there is provided a method for face and body treatment, comprising:

automatically applying a first mode of treatment, selected from the group consisting of suction, macro-massage treatment, warming light treatment, infrared light treatment, UV light treatment, LLLT, RF treatment, pulsating magnetic field treatment, constant magnetic field treatment, electrostimulation treatment, cooling-diode treatment, warring-diode treatment, and cooling-warming-diode treatment; and

automatically applying a second mode of treatment, different from the first mode, the second mode of treatment being selected from the group consisting of suction, macro-massage treatment, warming light treatment, infrared light treatment, UV light treatment, LLLT, RF treat, pulsating magnetic field treatment, constant magnetic field treatment, electrostimulation treatment, cooling-diode treatment, warming-diode treatment, cooling-warming-diode treatment,

wherein the first and second modes of treatment may be selectively applied in tandem, and selectively applied in sequence, in accordance with predetermined restrictions.

Additionally, the first and second modes of treatment are applied in accordance with a predetermined schedule.

Additionally, the modes of treatment are self-applied.

According to one aspect of the present invention, there is provided an oxygen treatment device, comprising:

a canister containing a mixture of liquefied oxygen and a carrier;

an oxygen line, to which gaseous oxygen flows out of the canister; and

an applicator, for applying the gaseous oxygen.

Additionally, the device includes a regulating valve, for controlling the flow of the gaseous oxygen out of the canister.

Additionally, the applicator is a facial mask.

Additionally, the carrier is an aromatic oil.

Additionally, the device includes an airline, in communication with the oxygen line, via a connector, for mixing air with the gaseous oxygen.

According to one aspect of the present invention, there is provided a flexible material, formed of a plurality of pockets, arranged abut to each other, each pocket including:

an inlet and a solenoid valve, at the inlet; and

an outlet,

an airline, in communication with each inlet;

a power-and-control cable, in communication with each solenoid valve;

a controller, in communication with the airline and power and control cable, for controlling the air inflow to each pocket, so as to generate a pressure wave through the flexible material.

Additionally, the device is arranged as a soft hose, and further including a vacuum source, for creating a vacuum within a lumen defined by the soft hose, for operation as an erection device.

According to one aspect of the present invention, there is provided a cupping system, comprising:

a plurality of cups; and

at least one vacuum hose, in communication with thc cups, and in communication with a vacuum source, for providing a vacuum to the cups.

Additionally, the system includes a regulating system, for controlling the vacuum within the cups.

According to one aspect of the present invention, there is provided a face-and-body-treatment, laptop-like kit, comprising:

a computerized device, built into the laptop-like kit; and

a mirror, built into a cover portion of the laptop-like kit, for self-application of face-and-body treatments; and

at least one treatment device, stored within an inner space of the laptop-like kit.

Additionally, the kit includes a power source.

Additionally, the power source is rechargeable.

Additionally, the kit includes a control panel, for the at least one electrical control feature and the display screen.

Additionally, the kit includes a vacuum pump.

Additionally, the at least one treatment device is a suction treatment device, having a suction hose, coiled in a duct within the inner space, and sized so as to exactly fit within the duct.

Additionally, the kit includes a compressor.

Additionally, the at least one treatment device comprises at least two treatment devices, stored within an inner space of the laptop.

Additionally, the mirror includes a lighting system.

Additionally, the mirror includes a magnification portion.

Additionally, the kit includes a magnification lens, attached to the mirror.

Additionally, the mirror includes flaps, for viewing from a side angle.

Additionally, the flaps are adjustable for different viewing angles.

Additionally, the minor is removable and detachable, for viewing from different positions and angles.

Additionally, the display panel is arranged on the mirror.

Additionally, the control panel is arranged along the mirror.

Additionally, the kit is arranged in a carrying trunk, and further including a pump, arranged within the carrying trunk.

Additionally, the kit includes a compressor, arranged within the carrying trunk.

Additionally, the at least one treatment device is adapted for applying a mode of treatment, selected from the group consisting of suction treatment, suction, macro massage treatment, cupping treatment, warming light treatment, white-light halogen treatment, white-light fluorescent treatment, far infrared light treatment, medium infrared light treatment, near infrared light treatment, UV light treatment, Low Level Laser Treatment (LLLT), RF treatment, ultrasound treatment, pulsating magnetic field treatment, constant magnetic field treatment, electrostimulation treatment, microcurrent treatment, cooling-diode treatment, warming-diode treatment, mechanical epilation, photoepilation, ultrasound epilation, hair drying, electric hair setting, rotating-hair-brush hair rolling, nail drying, oxygen treatment, oxygen peeling, ozone treatment, steam treatment, sandblasting peeling, face-and-body-cleaning-moisturizing-and-massaging treatment, lymphatic massage treatment, and air-brush makeup application.

Additionally, the at least one treatment device is adapted for applying at least two different modes of treatment, selected from the group consisting of suction treatment, suction, macro massage treatment, cupping treatment, warming light treatment, white-light halogen treatment, white-light fluorescent treatment, far infrared light treatment, medium infrared light treatment, near infrared light treatment, UV light treatment, Low Level Laser Treatment (LLLT), RF treatment, ultrasound treatment, pulsating magnetic field treatment, constant magnetic field treatment, electrostimulation treatment, microcurrent treatment, cooling-diode treatment, warming-diode treatment, mechanical epilation, photoepilation, ultrasound epilation, hair drying, electric hair setting, rotating-hair-brush hair rolling, nail drying, oxygen treatment, oxygen peeing, ozone treatment, steam treatment, sandblasting peeling, face-and-body-cleaning-moisturizing-and-massaging treatment, lymphatic massage treatment, and air-brush makeup application.

According to one aspect of the present invention, there is provided a face-and-body-treatment system, built into a dresser, comprising;

a computerized device, built into the dresser;

a mirror, built onto the dresser, for self-application of face-and-body treatments; and

at least one treatment device, stored within the dresser.

Additionally, the system includes a control panel, for the at least one electrical control feature and the display screen.

Additionally, the system includes a power source.

Additionally, the system includes a vacuum pump.

Additionally, the system includes a compressor.

Additionally, the at least one treatment device comprises at least two treatment devices, stored within an inner space of the dresser.

Additionally, the mirror includes a lighting system.

Additionally, the minor includes a magnification portion.

Additionally, the system includes a magnification lens, attached to the mirror.

Additionally, mirror includes flaps, for viewing from a side angle.

Additionally, the flaps are adjustable for different viewing angles.

Additionally, the mirror is removable and detachable, for viewing from different positions and angles.

Additionally, the display panel is arranged on the mirror.

Additionally, control panel is arranged along the mirror.

Additionally, the at least one treatment device is adapted for applying a mode of treatment, selected from the group consisting of suction treatment, suction, macro massage treatment, cupping treatment, warming light treatment, white-light halogen treatment, white-light florescent treatment, far infrared light treatment, medium infrared light treatment, near infrared light treatment, UV light treatment, Low Level Laser Treatment (LLLT), RF treatment, ultrasound treatment, pulsating magnetic field treatment, constant magnetic field treatment, electrostimulation treatment, microcurrent treatment, cooling-diode treatment, warming-diode treatment, mechanical epilation, photoepilation, ultrasound epilation, hair drying, electric hair setting, rotating-hair-brush hair rolling, nail drying, oxygen treatment, oxygen peeling, ozone treatment, steam treatment, sandblasting peeling, face-and-body-cleaning-moisturizing-and-massaging treatment, lymphatic massage treatment, and air-brush makeup application.

Additionally, the at least one treatment device is adapted for applying at least two different modes of treatment, selected from the group consisting of suction treatment, suction, macro massage treatment, cupping treatment, warming light treatment, white-light halogen treatment, white-light fluorescent treatment, far infrared light treatment, medium infrared light treatment, near infrared light treatment, UV light treatment, Low Level Laser Treatment (LLLT), RF treatment, ultrasound treatment, pulsating magnetic field treatment, constant magnetic field treatment, electrostimulation treatment, microcurrent treatment, cooling-diode treatment, warming-diode treatment, mechanical epilation, photoepilation, ultrasound epilation, hair drying, electric hair setting, rotating-hair-brush hair rolling, nail drying oxygen treatment, oxygen peeling, ozone treatment, steam treatment, sandblasting peeling, face-and-body-cleaning-moisturizing-and-massaging treatment, lymphatic massage treatment, and air-brush makeup application.

According to one aspect of the present invention, there is provided a spout, for face and body treatment, comprising:

a casing, having an inner chamber and a proximal surface, with respect to a portion of the body, for applying a suction treatment to the portion of the body, and

at least one ultrasound transducer, mounted on the proximal surface, for applying an ultrasound treatment to the portion of the body.

Additionally, the spout includes a plurality of ultrasound transducer.

Additionally, the spout includes a gripping handle.

Additionally, the spout is connected to a computerized face and body treatment system, and controlled by a computes of the face and body treatment system.

Additionally, the spout is detachably connected to the computerized face and body treatment system.

Additionally, the spout includes at least one control feature, which communicates with the computer.

Additionally, the spout is adapted for applying at least one additional mode of treatment, selected from the group consisting of warming light treatment, white-light halogen treatment, far infrared lift treatment, medium infrared light treatment, near infrared light treatment, UV light treatment, Low Level Laser Treatment (LLLT), RF treatment, pulsating magnetic field treatment, constant magnetic field treatment, electrostimulation treatment, cooling-diode treatment, warming-diode treatment, mechanical epilation and photoepilation.

According to another aspect of the present invention, there is provided a device, for face and body treatment, comprising:

at least one ultrasound transducer, mounted on the proximal surface, for applying an ultrasound treatment to the portion of the body; and

at least one additional mode of treatment, selected from the group consisting of warming light treatment, white-light halogen treatment, far infrared light treatment, medium infrared light treatment, near infrared light treatment, UV light treatment, Low Level Laser Treatment (LLLT), RF treatment, pulsating magnetic field treatment, constant magnetic field treatment, electrostimulation treatment, cooling-diode treatment, warming-diode treatment, mechanical epilation and photoepilation

According to another aspect of the present invention, there is provided a spout, for ace and body treatment comprising:

a casing, having an inner chamber and a proximal surface, with respect to a portion of the body, for applying a suction treatment to the portion of the body; and

at least electromagnet, incorporated within the casing, for applying a magnetic-field treatment to the portion of the body.

Additionally, the magnetic-field treatment is a pulsating magnetic-field treatment.

Additionally, the spout is attached to a gripping handle.

Additionally, the spout is connected to a computerized face and body treatment system, and controlled by a computer of the face and body treatment system.

Additionally, the spout is detachably connected to the computerized face and body treatment system.

Additionally, the spout includes at least one control feature, which communicates with the computer.

Additionally, the spout is adapted for applying at least one additional mode of treatment, selected from the group consisting of warming light treatment, white-light halogen treatment, far infrared light treatment, medium infrared light treatment, near infrared light treatment, UV light treatment, Low Level Laser Treatment (LLLT), RF treatment, ultrasound treatment, electrostimulation treatment, cooling-diode treatment, warming-diode treatment, mechanical epilation and photoepilation.

According to another aspect of the present invention, there is provided a device, for face and body treatment, comprising:

at least electromagnet, incorporated within the casing, for applying a magnetic-field treatment to the portion of the body, and

at least one additional mode of treatment, selected from the group consisting of warming light treatment, white-light halogen treatment, far infrared light treatment, medium infrared light treatment, near infrared light treatment, UV light treatment, Low Level Laser Treatment (LLLT), RF treatment, ultrasound treatment, electrostimulation treatment, cooling-diode treatment, warming-diode treatment, mechanical epilation and photoepilation.

The present invention addresses the shortcomings of presently known configurations by providing arrangements and packaging of multi-device, face-and-body-treatment systems, for adapting these systems to self-application and to home use. In particular, a multi-device, face-and-body-treatment, laptop-like kit is described, for beauty treatment “on the go.” Additionally, a multi-device, face-and-body-treatment system built into a dresser is taught, for beauty treatment in the home. Other arrangements are also described.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. In case of conflict, the patent specification, including definitions, will control. In addition, the materials, methods, and examples are illustrative only and not intended to be limiting.

### BRIEF DESCRIPTION OF THE DRAWINGS

The invention is herein described, by way of example only, with reference to the accompanying drawing. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIGS. 1A-1I schematically illustrate a device for face and body treatment, in accordance with a preferred embodiment of the present invention;

FIGS. 2A-2F schematically illustrate spouts for applying suction to the skin, in accordance with preferred embodiments of the present invention;

FIGS. 3A-3C schematically illustrate spouts, comprising at least one light source, for providing light treatment, in accordance with preferred embodiments of the present invention;

FIGS. 4A-4B schematically illustrate spouts, comprising an ultrasound transducer, in accordance with a preferred embodiment of the present invention;

FIGS. 5A-5B schematically illustrate spouts, comprising an electromagnet, in accordance with preferred embodiments of the present invention;

FIGS. 6A-6C schematically illustrate a spout, comprising electrostimulating electrodes, for providing electrostimulation treatment, in accordance with preferred embodiments of the present invention;

FIG. 7 schematically illustrates a spout, comprising cooling diodes, for providing cooling-diode treatment, in accordance with a preferred embodiment of the present invention;

FIG. 8 schematically illustrates a spout, comprising laser diodes and cooling diodes, in accordance with a preferred embodiment of the present invention;

FIGS. 9A and 9C schematically illustrate spouts, designed for light-induced hair removal, in accordance with preferred embodiments of the present invention;

FIGS. 10A-10B schematically illustrate spouts, designed for mechanical hair removal, in accordance with preferred embodiments of the present invention;

FIGS. 11A-11D schematically illustrate a device and a snout, adapted for use with a standard vacuum cleaner;

FIG. 12 schematically illustrates a spout, ated for ring impotence;

FIGS. 13A-13C schematically illustrate power-and-control consoles, in accordance with preferred embodiments of the present invention;

FIG. 14 schematically illustrates a system for face and body treatment, in accordance with a preferred embodiment of the present invention;

FIGS. 15A and 15B are arranged as tables, which delineate predetermined restrictions regarding the different features and different modes of treatment, in accordance with the present invention;

FIGS. 16A and 16B are before and after color photos of a first woman that underwent a treatment, in accordance with the present invention;

FIGS. 17A and 17B are before and after color photos of a second woman that underwent a vacuum treatment, in accordance with the present invention;

FIGS. 18A-18F schematically illustrate a plurality of devices for face, body and hair treatments, which may be included with the system of FIG. 14, in accordance with preferred embodiments of the pent invention;

FIGS. 19A-19B schematically illustrate the power-and-control console in accordance with other preferred embodiments of the present invention;

FIGS. 20A-20D schematically illustrate a plurality of devices for face, body and hair treatments, which may be included with the system of FIG. 14, in accordance with other preferred embodiments of the present invention;

FIG. 21 schematically illustrates the system for face and body treatment, as a self contained system, arranged in a carrying case, in accordance with another preferred embodiment of the preset invention;

FIGS. 22A-22C schematically illustrate the system for face and body treatment adapted for sandblasting peeling, in accordance with another preferred embodiment of the present invention;

FIG. 23A schematically illustrates an oxygen or ozone therapy device, in accordance with a preferred embodiment of the present invention;

FIG. 23B schematically illustrates a steam therapy device, in accordance with a preferred embodiment of the present invention;

FIGS. 24A-24C schematically illustrate a lymphatic massage device, in accordance with a preferred embodiment of the present invention;

FIG. 25 schematically illustrates an erection massage device, in accordance with a preferred embodiment of the present invention;

FIG. 26 schematically illustrates a cupping device, in accordance with a preferred embodiment of the present invention;

FIG. 27 schematically illustrates a face-and-body-treatment system for home use of the woman, in accordance with a preferred embodiment of the present invention;

FIG. 28 schematically illustrates a face-and-body-treatment system for home use of the man, in accordance with a preferred embodiment of the present invention;

FIG. 29 schematically illustrates a face-and-body-treatment system for clinics, in accordance with a preferred embodiment of the present invention;

FIGS. 30A-30P schematically illustrate a face-and-body-treatment, laptop-like kit, in accordance with a preferred embodiment of the present invention;

FIGS. 31A-31C schematically illustrate a face-and-body-treatment, laptop-like kit, integrated with a larger trunk, in accordance with the present invention;

FIGS. 32A-32B schematically illustrate a face-and-body-treatment kit, in accordance with another preferred embodiment of the present invention;

FIGS. 33A-33G schematically illustrate a dresser, for housing a face-and-body-treatment system, in accordance with another preferred embodiment of the present invention;

FIG. 34 illustrates a face-and-body-treatment-system built into a chair, in accordance with the present invention; and

FIGS. 35A-35D schematically illustrate built-in systems for face and body treatments, in accordance with the present invention.

### DESCRIPTION OF THE PREFERRED EMBODIMENTS

The present invention is of arrangements and packaging of multi-device, face-and-body-treatment systems, for adapting these systems to self-application and to home use. Specifically, the present invention is of a multi-device, face-and-body-treatment laptop-like kit, for beauty treatment “on the go,” and of a multi-device, face-and-body-treatment system built into a dresser, for beauty treatment in the home. Other arrangements are also described.

The principles and operation of a the device and method according to the present invention may be better understood with reference to the drawings and accompanying descriptions.

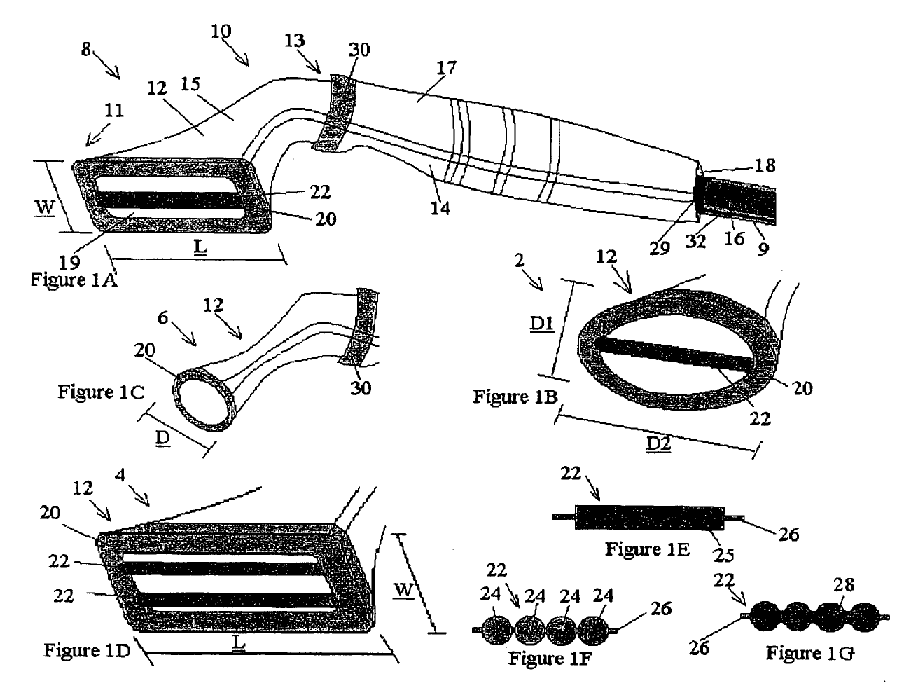

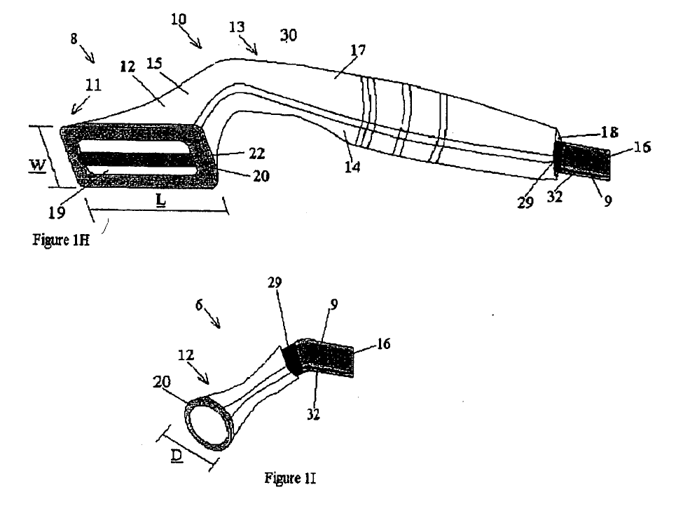

Referring now to the drawings, FIGS. 1A-1I schematically illustrate a device 10 for face and body treatment, in accordance with a preferred embodiment of the present invention. Device 10 is a massage device, which employs suction, imitating the conventional massaging method, “palpate and roll”, and stimulating blood circulation.

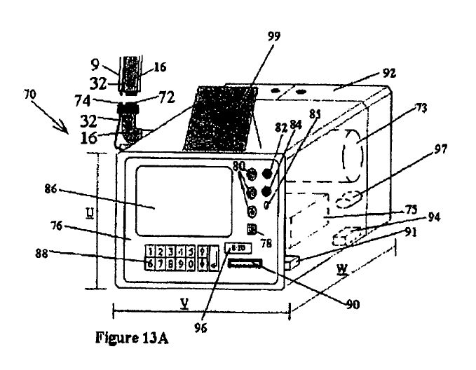

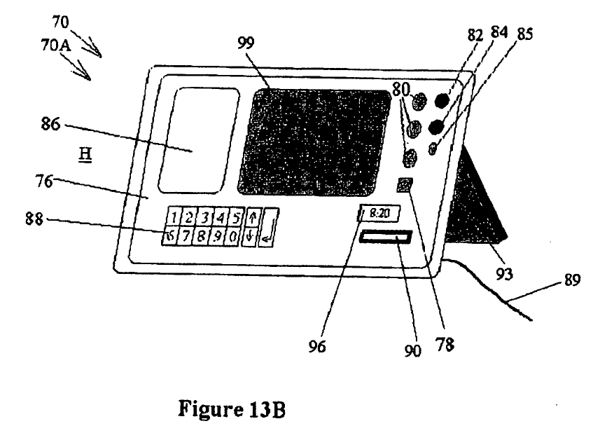

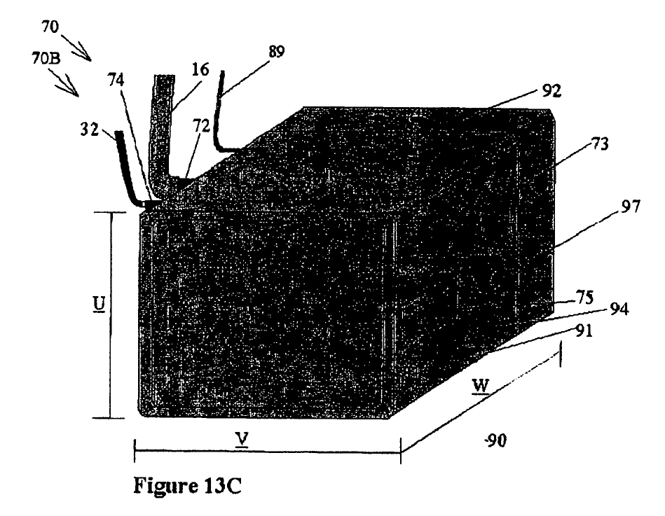

Device 10 includes a spout 12, adapted for gliding along a portion of a body and applying suction thereto. Spout 12 has proximal and distal ends, 11 and 13, with respect to the body, and a casing 15, which defines an inner chamber 19 therein, operative at a pressure below atmospheric pressure, for applying suction to the tissue. Spout 12 is attached to a gripping handle 14, at distal end 13. Gripping handle 14 has a casing 17, which defines a lumen 18, wherein a vacuum hose 16 is arranged, for providing suction to spout 12. Additionally, a power-and-control line 32, described hereinbelow in conjunction with FIGS. 13A-13C, is embedded within casing 15, or within lumen 18. Preferably, vacuum hose 16 and power-and-control line 32 reach device 10 together, enclosed within a sheath 9. Alternatively, they may reach device 10 separately. A connector 7, for selectively connecting and disconnecting device 10

Preferably, gripping handle 14 connects with vacuum hose 16 and power-and-control line 32 via a connector 29. Connector 29 may also have a swivel motion, for example of 90 or 120 degrees. Connector 29 may be located on device 10 or along vacuum hose 16 and power-and-control line 32.

Preferably, device 10 is aesthetically designed and colored. A choice of colors may be provided. Casing 15 of spout 12 and casing 17 of gripping handle 14 may bc formed of a rigid plastic, for example, PVC, a combination of wood and plastic, a combination of natural or synthetic rubber and plastic, or thc like.

At proximal end 11, spout 12 has a surface 20, which makes contact with the portion of the body under treatment, as device 10 glides along it. Surface 20 may be elliptical, circular, rectangular or of another shape, and is preferably formed as a replaceable pad, preferably of silicon, or another material that is preferably biocompatible, nonallergenic, and soft to the touch. During use, a lubricant, such as a facial cream or a gel may bc used between surface 20 and skin 40.

In accordance with a preferred embodiment of the present invention, a plurality of spouts 12 may be provided, of different sizes and shapes, each adapted for a particular portion of the body. For example, for applying suction generally to the face, a rectangular spout 8 of FIG. 1A, for example, having a length L substantially of 25 mm, and a width W substantially of 10 mm, with an inner roller of substantially 3 mm in diameter, may be used. Alternatively, an elliptical spout 2 of FIG. 1B, for example, having a minor diameter D1 substantially of 10 mm, and a major diameter D2 substantially of 25 mm, may be used. Alternatively, a circular spout 6, of FIG. 1C, for example, of a 30-mm circular cross, section may be used. Yet, for the area under the eyes, circular spout 6 of FIG. 1C, may have a diameter of between 4 and 15 mm. For applying suction to other portions of the body, for example, the thighs, a double-roller rectangular spout 4 of FIG. 1D, which is much larger than that of FIG. 1A, and may be, for example, substantially of 75 mm in length, and 35 mm in width, may be chosen. It will bc appreciated that these choices se individual, and different users may select differently. It will be further appreciated that other dimensions may similarly be used.

Spout 12 may be affixed onto gripping handle 14 in a manner similar to that by which different attachments are affixed onto a vacuum cleaner. For example, gripping handle 14 may include a connector 30, operative as a socket, for receiving distal end 13 of spout 12. Preferably connector 30 has a swivel motion, for example of 90 or 120 degrees.

Alternatively, spout 12 may be permanently connected to gripping handle 14.

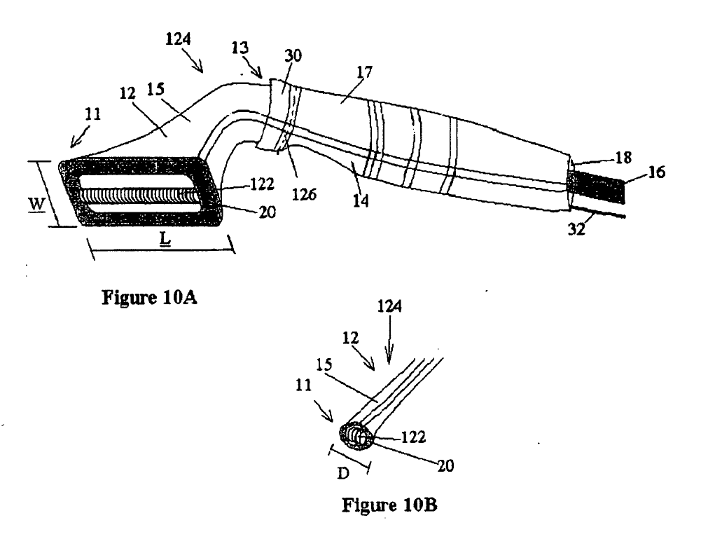

Additionally, device 10 may include at least one roller 22, arranged at proximal end 11, and protruding proximally from surface 20, for increasing the massaging action to the portion of the body under treatment. As shown in FIG. 1E, roller 22 may be a cylinder 25, arranged on a shaft 26. Alternatively, as shown in FIG. 1F, roller 22 may include balls 24 arranged on shaft 26. Alternatively, as shown in FIG. 10, roller 22 may have a wavy structure 28, arranged on shaft 26. Alternatively, another roller may be used. Roller 22 may be formed, for example, of rigid plastic, PVC, wood, natural or synthetic rubber, or another suitable material. Alternatively, a bar 22, which does not rotate with the motion of spout 12, may be used.

Preferably, roller 22 may be selectively inserted into spout 12 when a massaging action is desired, and selectively removed from spout 12, for suction without massage. Additionally, spout 12 may be provided with several rollers 22, for example, from amongst those seen in FIGS. 1E-1G, and a user (not shown) may select roller 22 of a desired shape. Furthermore, spout 12 may be adapted to include two or more rollers, as seen in FIG. 1D. Preferably, roller 22 is manually powered, arranged to roll as spout 12 glides along the portion of the body under treatment. Alternatively, roller 22 may be electrically powered.

In accordance with the present invention, the actions of both casing 15 and at least one roller 22 are denoted macro-massage, to distinguish them from electrically assisted forms of treatment that may involve micro-massage, for example, ultrasound.

As seen in FIG. 1H, spout 12 and device 14 may be integrated into a single unit, forming device 10, adapted to fit into connector 29, in a manner similar to that by which different attachments are affixed onto a vacuum cleaner. A plurality of devices 10 may be provided.

Alternatively, gripping handle 14, or device 10, may be permanently connected to vacuum hose 16 and power-and-control line 32.

Alternatively as seen in FIG. 1I, spout 12 may be directly adapted to fit into connector 29, in a manner similar to that by which different attachments are affixed onto a vacuum cleaner.

Alternatively, spout 12, forming device 10, may be permanently connected to vacuum hose 16 and power-and-control line 32.

may be permanently connected to vacuum hose 16 and power-and-control line 32.

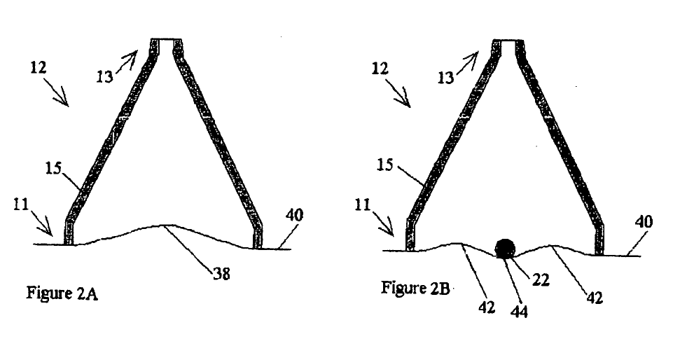

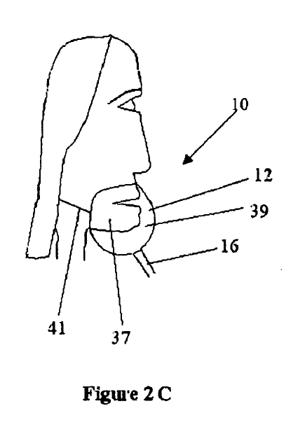

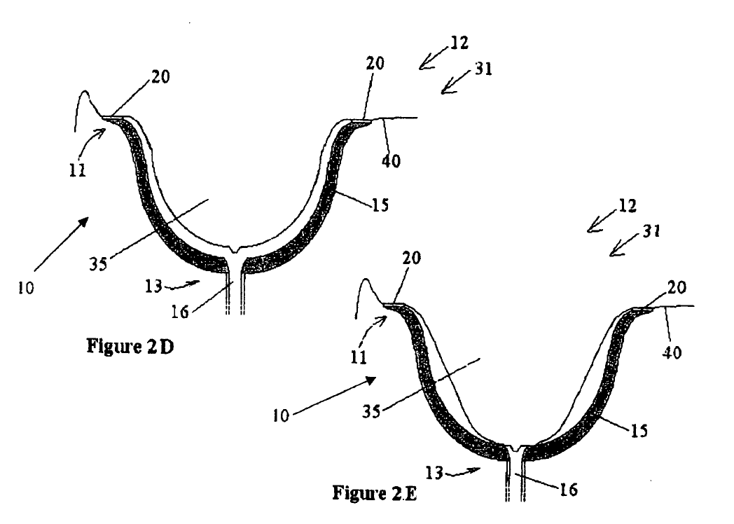

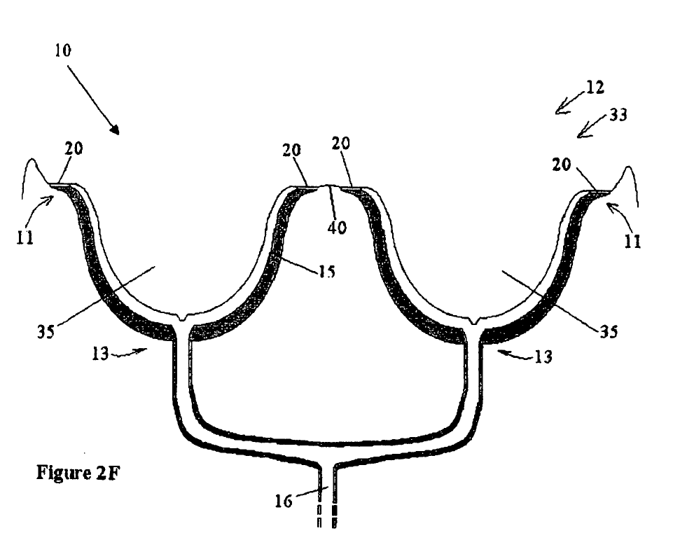

Referring further to the drawings, FIGS. 2A-2B schematically illustrate spouts 12, for applying suction to skin 40, in accordance with preferred embodiments of the present invention.

As seen in FIG. 2A, when suction is applied to skin 40, a skin hump 38 is formed within spout 12. As device 10 is moved across the body, skin hump 38 is rolled over by casing 15, to produce the massaging action.

It will be appreciated that the suction may be steady or pulsating, with varying pulsation duration and suction power. Additionally, pulsating suction may include pause for example:

i. a pulse may include: suction-pause-release;

ii. a pulse may include: suction-pause-release-pause; and

iii. a pulse may include: suction-release.

The length of each pulse may vary, for example, from 0.1 seconds to 5 seconds. It will be appreciated that other values may similarly be used. The time division between the portions of the pulse, for example, suction, pause, and release, may be equal or different.

As seen in FIG. 2B, when suction is applied while roller 22 presses down on skin 40, two skin humps 42 are formed, separated by a skin depression 44, that is created by roller 22. Thus both casing 15 and roller 22 participate in the massaging action. It will be appreciated that roller 22 may be motorized or may rotate freely with the movement of spout 12.

It will be appreciated that the vacuum may be a pulsating a steady.

In accordance with the preset invention, the actions of both casing 15 and at least one roller 22 will be denoted macro-massage, to distinguish them from electrically assisted forms of treatment that may involve micro-massage, for example, ultrasound.

The range of vacuum may be, for example, between −350 and −500 mbars. Alternatively, it may be, for example, between −250 and −700 mbars. Alternatively, it may be, for example, between −25 and −900 mbars. It will be appreciated that other values may also be used.

The capacity may be, for example, between 200 and 400 liters per minute. Alternatively, it may be, for example, between 100 and 600 liters per minute. Alternatively, it may be, for example, between 50 and 1000 liters per minute. It will be appreciated that other values may also be used.

Clinical tests by LPG, (“Clinical and Skin Tissue Effects of Lift 6® Dermexpert Laboratory, LPG Systems, France, 2001) show that facial suction treatment, for example by spout 12 of FIG. 2A, tends to firm, and improve loose facial skin. Twenty four women with signs of loose face skin were evaluated clinically. The treatment schedule included 20 sessions during 8 weeks a follows: three sections a week for the firs four-week period and two sections a week for the second four-week period. The clinical evaluations included the following:

1. Cutaneous biopsies of elastic fibers (thin cut) in the papillary dermis showed an increase in oxytalan fibers, after the treatment. The oxytalan fibers were thick, well structure and perpendicular to the dermo-epidermal junction. Additionally the elastic fibers of the papillary dermis, themselves, were better structured.

2. Cutaneous biopsies of elastic fibers (thick cut) showed a thicker elastin network, after the treatment.

3. Cutaneous biopsies (thin cut) in the papillary dermis and superior reticular dermis showed denser collagen networks after the treatment.

4. The number of “crow's foot” wrinkles around the eyes decreased by about 17% and their depth decreased by about 22%, after the treatment.

Additionally, 73% of the women felt there was an improvement in their facial skin quality, after the treatment. For 52% of the women, sufficient improvement was maintained even two weeks after the treatment had ended.

Referring further to the drawings, FIG. 2C schematically illustrates spout 12, for applying suction to a chin and lower face area 37, in accordance with a preferred embodiment of the present invention. Preferably, spout 12 of the present embodiment has a shape 39 which is similar to that of a gas mask. Spout 12 of the present embodiment may be attached with a strap 41.

Clinical tests, by LPG, as described hereinabove, show a lower-chin volume decrease in 54% of the patients, after the four weeks of treatment, and in 70% of the patients after eight weeks of treatment.

Referring further to the drawings, FIGS. 2D-2E schematically illustrate device 10, which includes spout 12, shaped as a bra cup 31, for breast firming, by applying suction to a breast 35, in accordance with a preferred embodiment of the present invention. FIG. 2D illustrates a rest situation and FIG. 2E illustrates breast 35 under suction.

Preferably, bra cup 31 includes pad 20, which forms a seal with skin 40. Bra cup 31 may be provided in a range of sizes, preferably analogous to bra sizes. Spout 12 of the present embodiment may be attached to the body (not shown) with straps 41 (FIG. 2C).

Referring fixer to the drawings, FIG. 2F schematically illustrates device 10, wherein spout 12 is shaped as a double spout, forming bra cups 33, for breast firming, by applying suction simultaneously to the two breasts 35, in accordance with another preferred embodiment of the present invention. Pad 20, which preferably forms a seal with the skin, may form a bridge between two bra cups 33. Alternatively, they are maneuvered generally independently. Double spouts 12 of the present embodiment may be attached to the body (not shown) with straps 41 (FIG. 2C).

Preferably, suction to breasts 35 is applied in pulses, of between 1 and 15 seconds each, and preferably of 2-3 seconds each. The amplitude of the suction pulse may be between −25 and −350 mm Hg. Preferably, the suction pulses have a sharp rise and a relatively slow decay. Alternatively, square or sinusoidal pulses may be used.

Clinical tests by LPG, as described hereinabove, show that suction treatment tends to firm, lift and improve the shape of pendulous breasts. For example, given a treatment schedule of 12 sessions during four weeks (three times a week, for 20 minutes), or 19 Caucasian women between thc ages of 26 and 43, 84% of the women reported a lifting effect, that remained even two weeks after the treatment had ended. The lifting effect was expressed by a decrease in the distance between the shoulder and the nipple, from an average of 21.12 cm before the treatment, to 20.41 after two weeks of treatment, 20.55, at the end of the four-week treatment, and 20.68, two week after the end of the treatment.

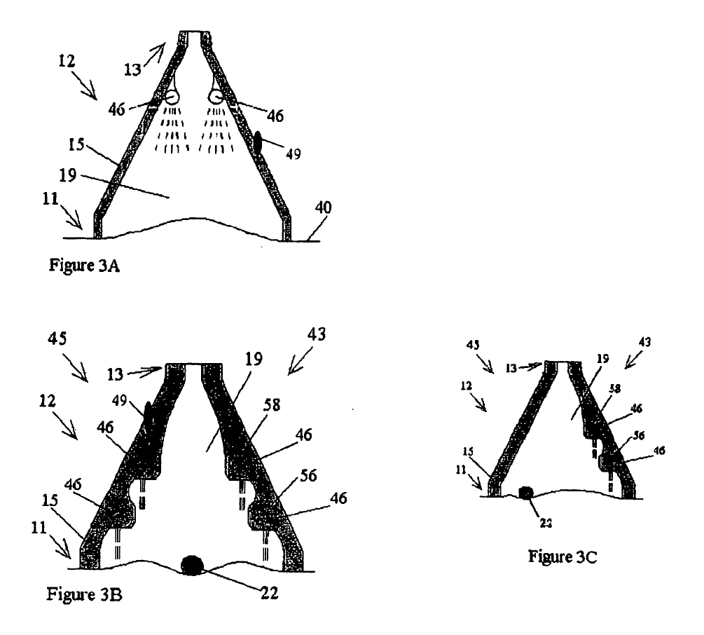

In accordance with the present invention, device 10 for includes at least one feature, integrated with spout 12, for applying at least one mode of treatment, for example, selected from the group consisting of warming light treatment, white-light halogen treatment, white-light fluorescent treatment far infrared light treatment, medium infrared light treatment near inured light treatment, UV light treatment, Low Level Laser Treatment (LLLT), ultrasound treatment, pulsating magnetic field treatment, constant magnetic field treatment, electrostimulation treatment, cooling diode treatment, warming-diode treatment, mechanical epilation and photoepilation, as described hereinbelow, in conjunction with FIGS. 3A-15. [XXX Sima, please make sure it is all there.]

Referring fib to the drawings, FIGS. 3A-3B schematically illustrate spouts 12, comprising at least one light source 46, for providing light treatment, in accordance with preferred embodiments of the present invention. Light treatment may comprise an inbred light treatment, for example, for providing primarily a warming effect to the tissue, and for cell renewal, UV light treatment, for photo treatment of dermatoses, especially psoriasis, and LLLT. It will be appreciated that a combination of these may be employed, in tandem or in sequence. It will be further appreciated that other forms of light treatment are also possible. In essence the light treatment may be any one of, or a combination of warming light treatment, far infrared light treatment, medium infrared light treatment, near infrared light treatment, UV light treatment, Low Level Laser Treatment (LLLT), and white-light halogen treatment and white-light fluorescent treatment.

Additionally, the light treatment may also be combined with RF treatment. For example, an RF coiled may be used in addition to or in place of the light diode.

As seen in FIG. 3A, warming light treatment may be provided with at least one light source 46 of one or several incandescent light bulbs, and (or) one or several halogen tubes, and (or) one or several infrared light sources, arranged within inner chamber 19 of spout 12. Preferably, a knob 49 may be used to turn off at least one light source 46, so as to apply vacuum only, when desired. It will be appreciated that knob 49 may be located on spout 12 or on gripping handle 14, of device 10.

Additionally or alternatively, infrared light treatment may be provided by providing one or sever infrared light sources 46, for example, arranged within inner chamber 19 of spout 12.

Alternatively, UV light treatment may be provided, for example by employing light source 46 as a low-pressure mercury vapor discharge lamp, as taught by U.S. Pat. No. 4,354,139, to Konijnendijk, et al., whose disclosure is incorporated herein by reference.

Alternatively, as seen in FIG. 3B, LLLLT may be provided by employing at least one light source 46 of one or several laser light sources, for example, laser diodes, preferably imbedded within casing 15. Preferably, knob 49 may be used to turn off at least one light source 46, so as to apply vacuum only, when desired.

According to Skylark Inc., “Laser Treatment, http://www.skylarkdevice.com/english/laser_e.htm, 2000-2001 and according to LLLT, http://www.medsolution.de/LLLT.htm, both downloaded on Apr. 23, 2002, LLLT promotes the production of collagen and the synthesis of protein, accelerates blood circulation, increases lymphatic flow, excites cell division, improves immunity, revives white corpuscles, stimulates the synthesis of Adenosin Tri Phosphate (ATP), and increases the synthetic energy of nucleic acid. Additionally, LLLT can stimulate the skin to improve its tension and elasticity, reduce wrinkles, remove scars, and slow down skin aging.

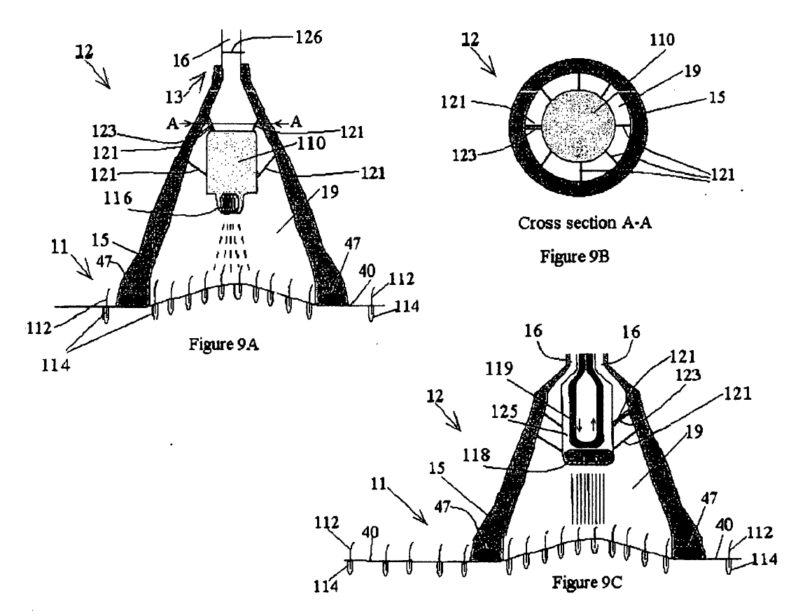

It will be appreciated that a cooling system may be used, for example, as described hereinbelow, in conjunction with FIG. 9B.

As seen in FIG. 3B, the laser light diodes may be arranged in a single tier of diodes, or as two or more tiers of diodes, for example, tiers 56 and 58, wherein each tier of diodes may include between one and four diodes. It will be appreciated that other numbers are also possible. The plurality of Laser light diodes may emit substantially the same wavelength. Alternatively, two or more wavelengths may be used, as taught, for example, by U.S. Pat. No. 4,930,504 to Diamantopoulos, and by U.S. Pat. No. 5,755,751, to Eckhouse, whose disclosures are incorporated herein by reference. For example, tier 56 may operate at a first wavelength, tier 58 may operate at a second wavelength, and additional tiers may be employed, operating at other wavelengths.

The laser light diodes may be pulsed or continuous. When pulsed laser is used, pulsation may take place between a left side 45 and a right side 43, or between tiers of diodes such as tiers 56 and 58. Where more tiers are used, they may be pulsed in sequence. Additionally or alternatively, where two or more wavelengths are employed, they may be pulsed in sequence.

When using laser light source, eye pads (not shown), are worn, for protection. Alternatively, special protective glasses (not shown) may be provided with device 10.

Irradiation by the two or more wavelengths may be simultaneous. Alternatively, it may be sequential. Alternatively, the user may select a predetermined radiation schedule, which may be simultaneous, sequential, or restricted to only one or only two wavelengths, from amongst the wavelengths that are available.

The irradiation wavelength range may be from below 200 to above 1500 nm. Specifically, the range 630-1200 nm may be used for biostimulation. The range 305-320 nm may be used for the treatment of psoriasis and other skin diseases. Additionally, as taught by U.S. Pat. No. 5,755,751, to Eckhouse, other wavelengths for example in the range 400-600, may be employed.

Laser light diodes 46 may be obtained, for example, from Photonic Devices, http://www.photonics.com. Alternatively, they may obtained from Coherent, www.coherent.com, which provide miniature laser diodes, of generally less than to mm in diameter and 2-3 mm in height.

It will be appreciated that a cooling system may be used, for example, as described hereinbelow, in conjunction with FIG. 9B.

FIG. 3C illustrates a different arrangement of roller 22 and light diodes 46, which is not symmetric.

It will be appreciated that light treatment may also be applied without vacuum, to the face and to various parts of the body.

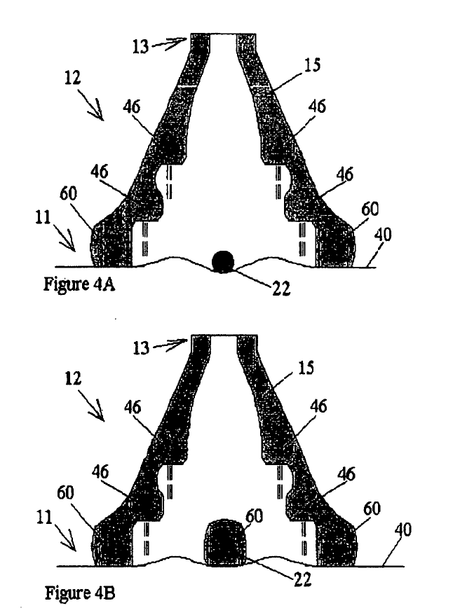

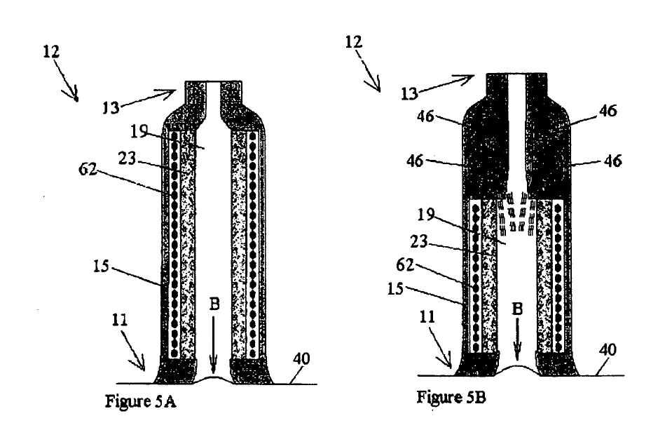

Referring further to the drawing, FIGS. 4A and 4B schematically illustrate spouts 12, comprising an ultrasound transducer 60, in accordance with preferred embodiments of the present invention, for providing ultrasound treatment.

According to “Ultrasound Treatment,” Skylark Inc., http://www.skylarkdevice.com/english/ultrasonic_e.htm#head, Ultrasound causes a massaging or vibrating action, which may be regarded as a micro-massaging action. A consequence of it is a heating action. Massaging with 1 MHz for ten minutes may cause a temperature increase of 0.5-1° C., at a tissue depth of 4-5 cm. The warming effect increases blood circulation and tissue metabolism. Ultrasound also causes cavitations of the interface material, which leads to a cleansing of the skin. Furthermore, ultrasound may be used for peeling. Additionally, ultrasound increases skin absorption of external matter, such as a moisturizer. Furthermore, ultrasound may be used for hair removal. The combination of massage and ultrasound is recommended for cellulite treatment.

Additionally, according to U.S. Pat. No. 6,325,769, whose disclosure is incorporated herein by reference, controlled application of ultrasound energy into the dermis layer reduces the extent of wrinkles and rejuvenate the skin. The ultrasound energy triggers a biological response that causes a synthesis of new connective tissue in the dermis through activation of fibroblast cells in the dermis without causing or requiring a significant irritation or a damage to the epidermis.

As seen in FIG. 4A, at least one, and preferably several ultrasound transducers 60 may be arranged within casing 15, so as to have direct contact with skin 40. Alternatively or additionally, one or several ultrasound transducers 60 may be arranged within roller 22, or bar 22, so as to have direct contact with skin 40. During use, a lubricant, such as a facial cream or a special gel may be used between surface 20 (FIG. 1A) and skin 40. Alternatively, collagen cream, or another beneficial cream may be used and absorbed by the skin as a result of the ultrasound action.

When using a continuous waveform, the frequency range may be about 1-5 MHz, at a recommended power of about 1 W/cm², for a treatment ime of about 15 minutes, for general muscle treatment. The recommended power is about 0.5 W/cm², and the recommended treatment time is about 8-10 minutes, for facial treatment. Alternatively, when using a pulse waveform, the recommended power is about 240 mW/cm², for about 15 minutes, for general muscle treatment, and about 120 mW/cm²W/cm², for about 8-10 minutes, for facial treatment. It will be appreciated that other values may be used.

Ultrasound transducer 60, in the frequency range between 50 kHz and 2 MHz, at sizes as small as 0.2 in. external diameter and 0.36 in. in height, may be obtained, for example, from Digital Wave Corporation, 11234-A East Caley Av., Englewood, Colo. 80111 USA, Tel 303-790-7559, Fax. 303-790-7567, www.digitalwave.com. It will be appreciated that other values may be used.

As seen in FIGS. 4A and 4B, spout 12 may further include at least one light source 46, which may be any of the light sources described hereinabove, in conjunction with FIGS. 3A-3B. Preferably, the user may select either the a light treatment, such as LLLT treatment, or the ultrasound treatment, or both, in tandem or in sequence.

It will be appreciated that the ultrasound treatment, with or without light, may also be applied without vacuum, to the face an to various parts of the body.

Referring further to the drawings, FIGS. 5A and 5B schematically illustrate spouts 12, comprising an electromagnet 62, for providing pulsating magnetic field treatment, or constant magnetic field treatment, in accordance with preferred embodiments of the present invention.

According to “Magnetic and Electromagnetic Treatment,” By David Ramey, www.here.organism/conntriib/ramey/magnet/html, Health Care Reality Check, downloaded on Nov. 20, 2001, some researchers believe that pulsating magnetic field may stimulate biological processes, pertinent for example, to osteogenesis, healing of chronic wounds, and neuronal regeneration.

Preferably, electromagnet 62 comprises a conducting wire coil 62, arranged within casing 15. Additionally, an inner casing 23, preferably formed of a molded rigid plastic containing iron beads, iron filings, or the like, for example at a ratio of 1 part iron to 3 parts plastic, may be used on the side of conducting wire coil 62 facing inner chamber 19, to increase the magnetic field generated by conducting wire coil 62. Alternatively, another ratio may be used. Alternatively, no iron beads may be used. When current flows in wire coil 62, a magnetic field B is formed. To generate a pulsating magnetic field, a pulsed DC voltage may be used. For example, a pulsed DC voltage having a rectangular wave form, pulsing at the rate of 10-60 cycles per minutes (CPM), the coil producing an average field of between 5 and 25 gauss may be used. It will be appreciated that other values may be used.

Alternatively, a constant DC voltage may be used, to form a constant magnetic field.

In accordance with the present invention, a permanent magnet may be used in place of wire coil 62, to form a constant magnetic field.

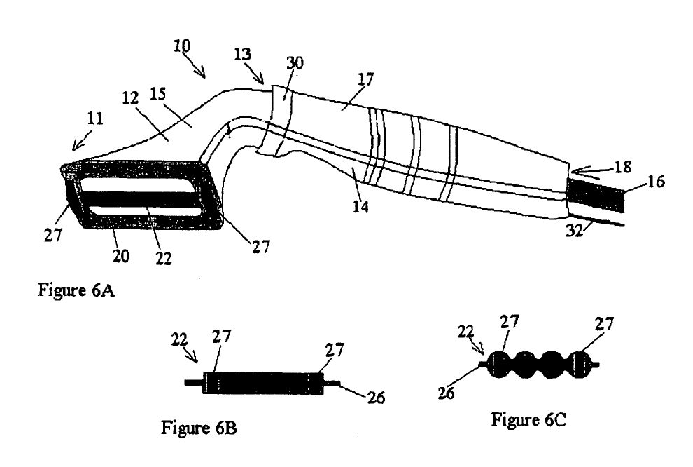

Referring further to the drawings, FIGS. 6A-6C schematically illustrate spout 12, comprising electrostimulating electrodes 27, for providing electrostimulation treatment, in accordance with preferred embodiments of the present invention.

As seen in FIG. 6A electrostimulating electrodes 27 may be arranged on surface 20. Alternatively, as seen in FIGS. 6B and 6C, electrostimulating electrodes 27 may be arranged on roller 22. Electrodes 27 may be formed, for example, of stainless steel, titanium, or titanium alloy or another preferably noncorrosive, biocompatible conducting metal.

Preferably, electrostimulation treatment is performed at between 6 V and 64 V, and up to 15 mA. It will be appreciated that other values may be used. The electrostimulation current may be based on AC, DC, and DC pulses of varying duration, for example, between 0.1 and 20 Hz.

It will be appreciated that the vacuum, in accordance with the present embodiment, may be used to maintain the electrodes on the face or body.

It will be appreciated that electrostimulation may also be applied without vacuum, to various parts of the body, for example, to the breast or to the stomach.

Microcurrent treatment may similarly be applied.

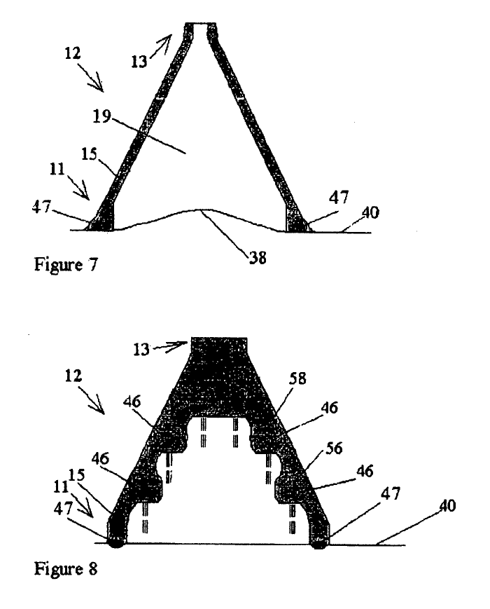

Referring further to the drawings, FIG. 7 schematically illustrates spout 12, comprising cooling diodes 47, arranged on surface 20, for providing cooling-diode treatment, in accordance with a preferred embodiment of the present invention. Cooling-diode treatment may be desired for example, to close the skin pores, at a conclusion of a treatment. Alternatively, cycles of heating and cooling may be employed, by combining for example, warming-light treatment and cooling-diode treatment.

Additionally, in accordance with an embodiment of the present invention, cooling diodes 47 may be selectively flipped by the user, when desired, so as to operate as warming diodes, for providing a warming effect, or warming-diode treatment.

Preferably, diodes 47 operate at between 7-10° C. colder or warmer than the skin. However, other temperature values are also possible. Preferably, diodes 47 operate at 12 V and up to 7 amp. It will be appreciated that other values may be used.

Referring further to the drawings, FIG. 8 schematically illustrates spout 12, comprising laser diodes 46, embedded within casing 15, and cooling diodes 47, arranged on surface 20, for providing LLLT, in combination with cooling-diode treatment in accordance with a preferred embodiment of the present invention. It will be noted that spout 12 of FIG. 8 is not adapted for applying the suction, macro-massage of FIGS. 2A-2B, but only other modes of treatment. Similarly, spout 12 may be adapted for light treatment with electrostimulation treatment, or ultrasound treatment with cooling diode treatment, or other combinations, in tandem or in sequence. Spout 12 may be further adapted for a combination of three or more modes of treatment, which may or may not include the suction, macro-massage of FIGS. 2A-2B.

Referring further to the drawings, FIGS. 9A and 9C schematically illustrate spouts 12, designed for light-induced hair removal, or photoepilation, in accordance with a preferred embodiment of the present invention.

As seen in FIGS. 9A and 9B, a photoepilation hair-removal device 110 may be attached to casing 15 of spout 12 by a structure 121, arranged for example, as a grid, so as not to block the suction in inner chamber 19. Additionally, power may be supplied to hair-removal device 110, via a power line 123, which may be embedded within structure 121.

Photoepilation hair-removal device 110 is adapted to burn hairs 112 and roots 114, on skin 40. Preferably, photoepilation hair-removal device 110 is similar to the SpaTouch, described in http://98.174.40.227//new/radiancy/radiancy, as well as in U.S. Pat. No. 6,214,034, to Azar, entitled, “Method of selective photothermolysis,” and in U.S. Pat. No. 6,187,001, to Azar, et al., entitled “Apparatus and method for removing hair,” whose disclosures are incorporated herein by reference. Thus, spout 12 of the present embodiment comprises a preferably pulsed light 116, which pulsates for example, in durations of 35 milliseconds, at a wavelength range favorable to melanin, over a very large spot size, for example, about 22×55 mm. It will be appreciated that other values may be used. Pulsed light source 116 may be a quarts light source.

It will be appreciated that although spout 12 seen in FIG. 9B is circular, other shapes, for example, rectangular, or elliptical may be used.

It will be appreciated that cooling diodes 47 may be used against skin 40, to alleviate the heat, generated by the photoepilation.

In accordance with the present invention, spout 12 applies suction to skin 40, for sucking the burnt hair ashes, through vacuum hose 16. A removable filter 126 may be used for collecting the ashes.

Spout 12 of the present embodiment can treat individuals with most skin and hair types. Te procedure works best, however, for people with dark brown or black hair and a fair complexion because of the color contrast and the fact that darker hair has a higher melanin content. Areas of the body that have been exposed to the sun or ultraviolet light in tanning booths should not be treated until one month after exposure.

Since dark colored hair tends to absorb light and burn more effectively than light colored hair, the user may dye hair 112, with a dye that infiltrates roots 114, prior to burning it. The dye may be a hair dye, as known, or liquid carbon, also known as Ferrite.

As seen in FIG. 9C, a laser photoepilation hair-removal device 125 may be attached to casing 15 of spout 12, for example, by structure 121. Additionally, power may be supplied to device 125 via power line 123, which may be embedded within structure 121.

Laser photoepilation hair removal device 125 may be basically similar to that of U.S. Pat. No. 6,273,885, to Koop, et al., Handheld photoepilation device and method, whose disclosure is incorporated herein by reference. Spout 12 of the present embodiment may thus include a semiconductor diode 118 or diode array laser 118 which emit energy at wavelengths preferably between about 630 nm and 980 =m, and delivers a predetermined amount of energy in a predetermined period of time. It will be appreciated that other values may be used.

Photoepilation hair-removal device 125 may include a cooling system 119, for example of water, air, or another fluid. The coolant system may be arranged within vacuum hose 16. Alternatively, spout 12 may include a finned, high heat-capacity material, as a heat sink, for passive cooling. Alternatively, another cooling system may be used, for example, cooling diodes.

It will be appreciated that power line 123 may be arranged along cooling system 119.

Additionally, as in FIG. 9A, cooling diodes may be used against skin 40, to alleviate the heat generated by the photoepilation.

In accordance with the present invention, spout 12 applies suction to skin 40, for sucking the burnt hair ashes.

Referring further to the drawings, FIGS. 10A-10B schematically illustrate spouts 12, designed as the Epilady, described in http://www.epiladyusa.com, as well as in U.S. Pat. No. 6,277,129, to Poran, entitled, “Dual ended hair remover,” whose disclosure is incorporated herein by reference, for mechanical hair removal, in accordance with a preferred embodiment of the present invention.

Thus, spout 12 of the present embodiments, operative as mechanical hair-removal device 124, has a series of high velocity rotating discs 122, operating like tweezers, that remove hair by the root. FIG. 10A illustrates a basic design, adapted for example, for women's legs, and FIG. 10B illustrates a miniature design, adapted for example, for facial hair, or as a sensitive trimmer for intimate areas.

In accordance with the present invention, inner chamber 19, around series of high velocity rotating discs 122, applies suction to the tissue, for sucking the hair away, through vacuum hose 16. A removable hair trap 126, or a hair filter 126, may be used for removing the hair.

Mechanical hair-removal device 124 may be attached to casing 15 of spout 12 by a structure 121, for example, as taught hereinabove, in conjunction with FIGS. 9A and 9B. Structure 121 is strong enough to withstand the vibrations of the mechanical epilation. Additionally, power may be supplied to hair-removal device 124, via power line 123, embedded within structure 121 (9A and 9B).

It will be appreciated that spouts 12, for example, as described in conjunction with FIGS. 1A-10B hereinabove need not be symmetric. For example, as described in conjunction with FIG. 3C, hereinabove.

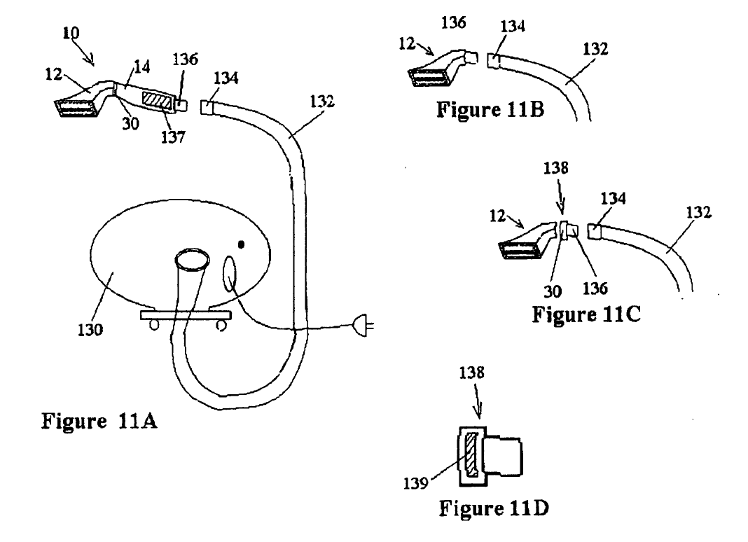

Referring further to the drawings, FIGS. 11A-11D schematically illustrate device 10 and spout 12, adapted for use with a standard vacuum cleaner 130, in accordance with preferred embodiments of the present invention.

As seen in FIG. 11A, device 10 may include a fitting 136, to enable use with a standard vacuum cleaner hose 132, having a fitting 134. Handle 14 of device 10 may further include a battery 137, for providing power to other features of spout 12, such as ultrasound or LLLT. Battery 137 may be rechargeable.

Alternatively, as seen in FIG. 11B, spout 12 may include fitting 136, to enable use with standard vacuum cleaner hose 132, having fitting 134.

Alternatively, as seen in FIG. 11C, a special adapter 138 may include fittings 136 and 134, to enable use with standard vacuum cleaner hose 132.

As seen in FIG. 11D, special adapter 138 may further include a battery 139, for providing power to other features of spout 12, such as ultrasound or LLLT. Battery 139 may be rechargeable.

Vacuum cleaner 130 may be a canister type vacuum cleaner, a brush type vacuum cleaner, a beater type vacuum cleaner, a hand-held, light, portable vacuum cleaner, such as a dust buster, a central, built-in vacuum cleaner, or any other vacuum cleaner, as known.

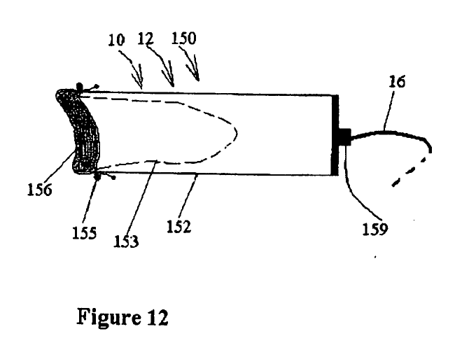

Referring further to the drawings, FIG. 12 schematically illustrates a spout, 12, designed as an erection implement 150, for treating impotence, in accordance with an embodiment of the present invention.

It is known that the application of vacuum to the penis is operative to bring about an erection. Spout 12 may be designed as erection implement 150, basically shaped as a soft, flexible hose 152, which connects to vacuum hose 16, via a connector 159. Additionally, flexible hose 152 includes a mouthpiece 156, adapted to form a seal with the body. Preferably, mouthpiece 156 is soft and flexible, formed for example, as an accordion, so as to adapt to the body shape. It will be appreciated that in accordance with the present embodiment, power-and-control-cable 32 need not be used.

In order to prevent fluids from reaching vacuum hose 16, a condom 153 may be used, inserted into erection implement 150, folded over the edges of mouthpiece 156, and held, for example, with a rubber band 155.

An erection may thus be stimulated by the application of vacuum to flexible hose 152.

Referring further to the drawings, FIG. 13A schematically illustrates a power-and-control console 70, in accordance with an embodiment of the present invention. Preferably, power-and-control console 70 is elegantly and attractively designed and colored. A choice of colors may be provided.

Power-and-control console 70 provides vacuum to vacuum hose 16, via a vacuum outlet 72, in communication with a vacuum source 73, and power to power-and-control line 32, via a power-and-control outlet 74, which may be, for example, a co-axial outlet, preferably receiving power from a power supply unit 75, and signals from a computerized device 91, decribed hereinbelow.

Additionally, power-and-control console 70 preferably includes a control panel 76, having an on/off control knob or control button 78 and preferably also several other knobs or buttons 80. Knobs 80 may be used to selectively activate different modes of treatment such as suction, mac massage treatment, ultrasound treatment, pulsating magnetic field treatment, LLLT and others. Preferably, knobs 80 may also control the intensity and other variables of the treatment. For example, when ultrasound treatment is selected, knobs 80 may be used to select the desired frequency, the desired power range, and the desired duration of treatment. Similarly, when LLLT is selected, knobs 80 may be used to select the desired wavelength or wavelengths, the desired power range, and the desired duration of treatment. Additionally, knobs 80 may be used to select a treatment schedule, such as LLLT with suction massage, or LLLT directly after the suction massage, or another treatment schedule.

Knobs 78 and 80 may also be located directly on gripping handle 14. This allows the user to initially turn device 10 on from power-and-control console 70, but pause or change treatment modes directly from gripping handle 14.

Additionally, control panel 76 may also include a display panel 86, which may display the feature or schedule that was selected. Display panel 86 may be interactive, so the user may touch it to select features or schedules. Alternatively or additionally, a keyboard 88 may be provided, for selecting a desired feature or schedule.

Power-and-control console 70 may further include computerized device 91, which may be, for example, a microcomputer 91 or another computerized system. Preferably, computerized device 91 includes a processor, which preferably includes a control unit, a logic unit (ALU) and memory. Additionally, computerized device 91 may include a fixed data storage device, such as a hard disk, and a read/write storage system 90 such as a diskette drive, a CD drive, or a mini CD drive, for storing or reading specific treatment schedules.

Furthermore, power-and-control console 70 may include a preferably digital timing device 96, such as a clock 96, or a stopwatch 96, in order to clock the duration of a treatment.

Additionally, power-and-control console 70 may include a preferably rechargeable battery 94.

Preferably, control panel 76 also includes a light 82, for indicating that the system is on. Preferably a second light 84 may be provided as a warning light for example, when the treatment time, or requested power level exceeds a recommended value. When this happens, computerized device 91 may stop the treatment.

Additionally, power-and-control console 70 may include a thermostat. A third light 85 may serve as a warning light, to indicate when power-and-control console 70 overheats. When this happens, computerized device 91 may stop the treatment.

Furthermore, power-and-control console 70 may include a short-circuit protection 97.

Preferably, a length V of power-and-control console 70 is 36 cm, a width W is 24 cm, and a height U is 13 cm. It will be appreciated that other dimensions are possible.

Power-and-control console 70 may further include a storage box 92 for storing accessories such as different spouts 12 and rollers 22, and a mirror 99, for allowing the user to view a facial treatment. Preferably, mirror 99 may be folded flat.

Referring further to the drawings, FIGS. 13B-13C schematically illustrate power-and-control console 70, in accordance with another embodiment of the present invention. Preferably, power-and-control console 70 is formed of a control-and-display portion 70A and a power-and-vacuum portion 70B. Power-and-vacuum portion 70B may be stored in a cabinet, or under a table, while control-and-display portion 70A, which may further include a support back 93, may be easily accessible kept over a table, or over a chest, or hung on the wall, or over a mirror. Control-and-display portion 70A is preferably elegantly and attractively designed and colored. A cable 89 may be used to conned control-and-display portion 70A and power-and-vacuum portion 70B.

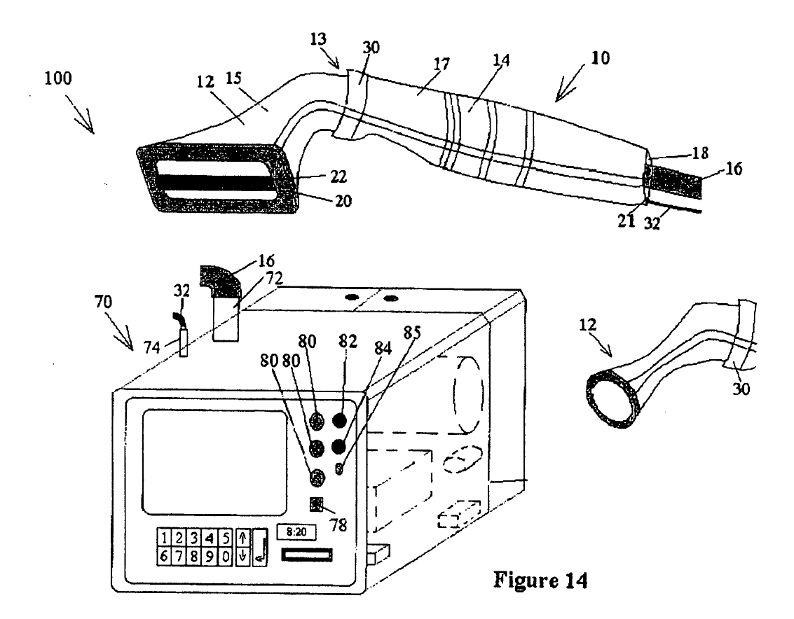

Referring further to the drawings, FIG. 14 schematically illustrates a face-and-body-treatment system 100, comprising power-and-control console 70 and at least one device 10, in accordance with an embodiment of the present invention. Device 10 includes at least one, and preferably two or more spouts 12. Additionally, several different devices 10 may be included.

Preferably, power-and-control console 70 is lightweight and portable, making system 100 portable. When battery 94, which is preferably rechargeable, is used, system 100 may be used “on thc go.” Preferably power-and-control console 70, device 10 and spouts 12 are arranged in an attractive carrying case, wherein power-and-control console 70 may be built into the carrying case.

In accordance with a preferred embodiment of the present invention, a plurality of spouts 12 may be provided, each having different features, adapted for a different modes of treatment and (or) different portions of the body. The different modes of treatment may include:

1. suction, macro-massage treatment, which may include one or more rollers (FIGS. 1A-1I, and 2A-2B);

2. lower-chin firming treatment (FIG. 2C);

3. breast firming treatment (FIG. 2D-2F);

4. light treatment (FIGS. 3A and 3B), which includes:

i. warming light treatment, (based on any one of infrared light, incandescent light or halogen light);

ii. infrared light treatment;

iii. UV light treatment;

iv. LLLT;

5. ultrasound treatment (FIGS. 4A-4B);

6. magnetic field treatment (FIGS. 5A-5B) which includes:

i. pulsating magnetic field treatment; and

ii. constant magnetic field treatment;

7. electrostimulation treatment (FIGS. 6A-6C);

8. cooling-diode treatment (FIG. 7);

9. warring diode treatment (FIG. 7);

10. photoepilation (FIGS. 9A-9C);

11. mechanical epilation (FIGS. 10A-10B); and

12. impotence treatment (FIG. 12);

13. various combinations (4A, 4B, 5B and 8)

In addition, spout 12 may combine several features, such as LLLT and ultrasound (FIGS. 4A and 4B), or LLLT and pulsating magnetic field treatment (FIG. 5B). Similarly, other combinations are possible. These may be applied in tandem, in sequence, in accordance with predetermined schedules, or at different times.

For example, spout 12 may be adapted for suction massage, and may fir include laser diodes ties 56 and 58 imbedded in casing 15 (FIG. 3B), cooling diodes 47 (FIG. 7), and ultrasound transducer 60, imbedded in roller 22 (FIG. 4B). A predetermined schedule, using spout 12, may comprise,

1. a first period of 10 min.: suction, macro-massage treatment with LLLT;

2. a second period of 5 min.: ultrasound treatment; and

3. a third period of 3 min.: cooling-diode treatment.

Alternatively, spout 12 may be adapted for suction massage, and may further include infrared light 46 (FIG. 3A), cooling diodes 47 (FIG. 7) and electrostimulating electrodes 27 (FIGS. 6A-6C). A predetermined schedule, using spout 12, may comprise,

1. a first period of 8 min.: suction, macro-massage treatment with infrared light treatment;

2. a second period of 8 min: electrostimulation treatment; and

3. a third period of 3 min.: cooling-diode treatment.

It will be appreciated that many other predetermined schedules are similarly possible. Additionally, it will be appreciated that spout 12 may be used for the application of a single treatment, such as only suction, macro-massage treatment, only LLLT, or only ultrasound treatment.

Thus, in accordance with the present invention, self-application of a variety of face and body treatments is possible with device 10. The user may adhere to a predetermined schedule, or alternate between schedules, for example, a first predetermined schedule on Sundays and Tuesdays, a second predetermined schedule on Mondays and Wednesdays, and a third predetermined schedule on Fridays. Preferably, the schedules are based on clinical recommendations for the frequency and duration of different forms of treatment. Recommended predetermined schedules may be provided on diskettes, CD's, or the like, with system 100.

Preferably, device 10 further includes knob 49 (FIGS. 3A-3B) to turn off any or all features, other than vacuum, when desired. Knob 49 may be located on spout 12 or on gripping handle 14, of device 10.

It will be appreciated that spout 12 and device 14 may be integrated into a single unit, forming device 10, and a plurality of devices 10 may be provided, rather than a plurality of spouts 12.

It will be appreciated that spout 12 or device 10 may be connected to a vacuum cleaner, as described in any of FIGS. 11A-11D.

It will be appreciated that vacuum hose 16 and power-and-control-cable 32 may be attached to device 10, with a detachable connector 29 (FIG. 1A) to power-and-control-console 70. Alternatively, they may be attached to power-and-control-console 70 with detachable connectors 72 and 74 (FIG. 13A). Additionally, only one of vacuum hose 16 and power-and-control-cable 32 may be used with a device 10.

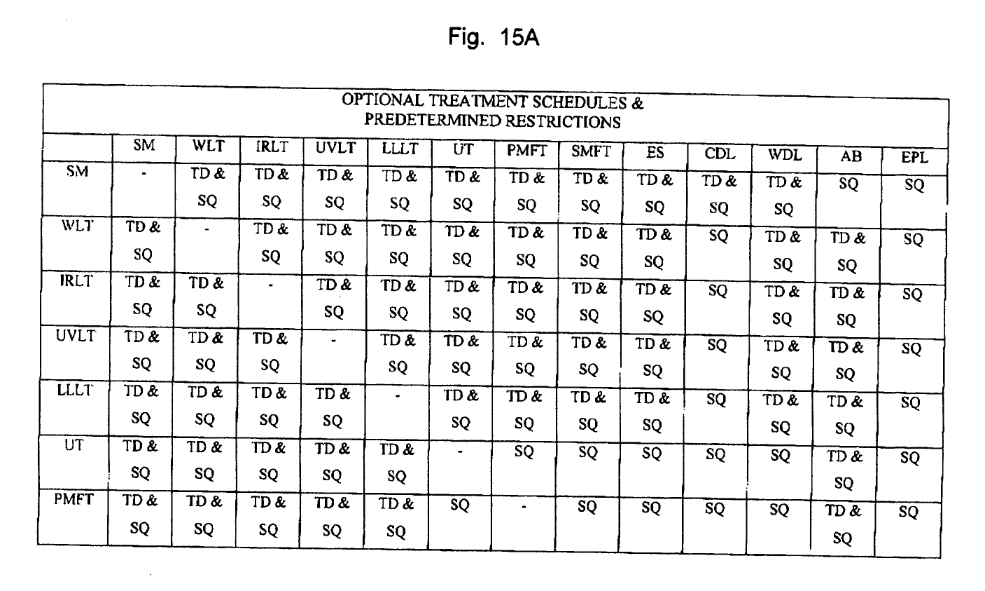

Referring further to the drawings, FIGS. 15A and 15B are arranged as tables, which delineate predetermined restrictions regarding the different feature and different modes of treatment, in accordance with the present invention. Certain modes of treatment, such as suction, macro-massage treatment and light treatment may be applied in tandem and in sequence. On the other hand, other modes may be applied only in sequence, as they interfere with each other. For example, electrostimulation is likely to interfere with the operation of a piezoelectric ultrasound transducer, thus tandem application of electrostimulation and ultrasound treatments is restricted. Similarly, cooling treatment will be ineffective, when conducted with warming light treatment, infrared light treatment, or with ultrasound treatment, all of which having warming effects on the tissue. In consequence, their tandem application is restricted.

It will be appreciated that some application treatment devices include various treatment features without vacuum, for example, a treatment device may include ultrasound transducers and LLLT, or an electromagnet and infrared diodes, without being adapted for vacuum applications.

It will be appreciated that computerized device 91 is adapted for storing desired optional schedules in a memory, and (or) reading desired operational schedules from the memory.

It will be appreciated that computerized device 91 is adapted for maintaining a treatment-schedule log, for follow-up of treatment application types, durations, operational parameters, and dates and hours of the applications. The log may be maintained by user ID, for several users.

The key to the acronyms of FIGS. 15A and 15B is as follows:

SM—suction, macro-massage treatment, with or without one or more rollers;

WLT—warming light treatment;

IRLT—infrared-light treatment

UVLT—ultraviolet-light treatment;

LLLT—low level laser treatment;

UT—ultrasound treatment;

PMFT—pulsating magnetic field treatment;

SMFT—constant magnetic field treatment;

ES—electrostimulation treatment;

CDL—cooling-diode treatment;

WDL—warming-diode treatment;

AB—air blowing

epilation—photoepilation or mechanical epilation;

TD & SQ—in tandem and in sequence; and

SQ—only in sequence.

It will be appreciated that a cooling system may be used with any of pouts 12, for example, as described in conjunction with FIG. 9B.

It will be appreciated that an oil or a cream which may be for example, a baby oil, a body lotion, a hand cream, a facial cream, a facial tonic, an aromatic oil or an aromatic cream may be used together with spout 12. However, spout 12 may also be used with no oil or cream.

In accordance with another preferred embodiment of the present invention, the user may buy system 100 with a limited number of spouts 12. Additionally, the user may upgrade his system 100 by buying additional spouts 12 at a later time.

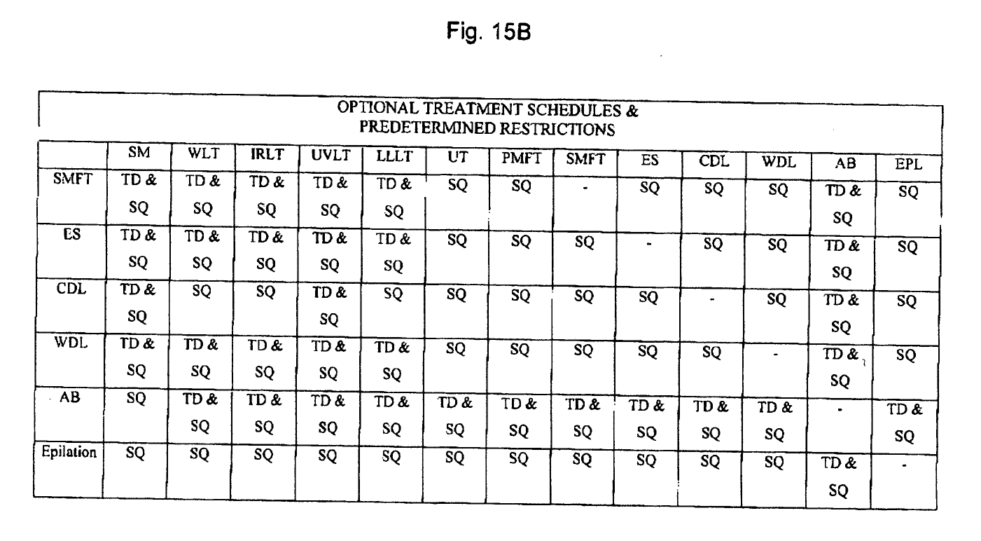

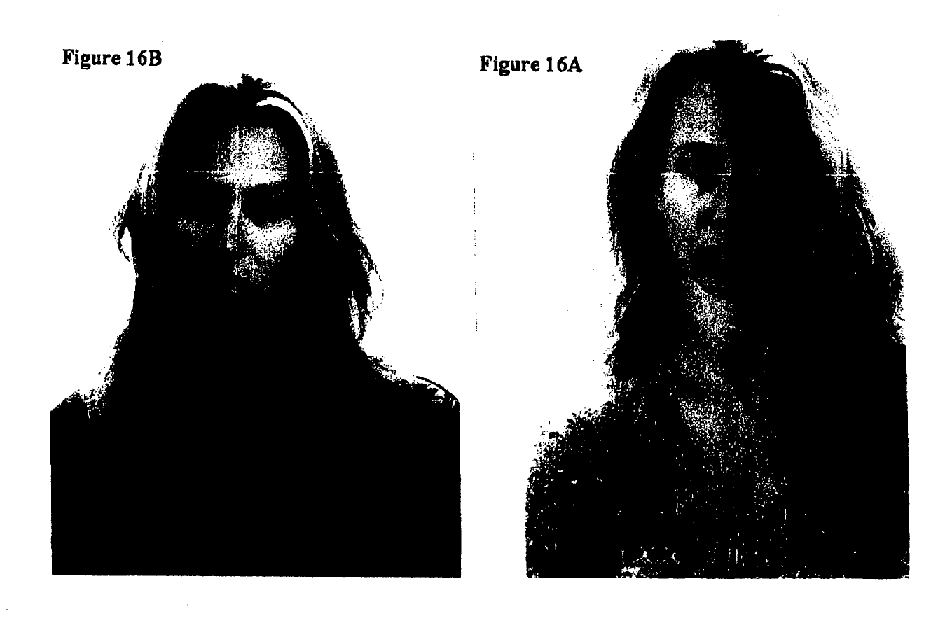

Referring further to the drawings, FIGS. 16A-16B are colored photographs of a 36-year old woman that underwent a vacuum treatment, in accordance with the present invention FIG. 16A was taken prior to the treatment and FIG. 16B was taken after two months of treatment. The treatment schedule was as follows:

During the 1^{st} week: 5 min, 2-3 times week, at 0.3-0.5 of 450 mbars.

During the 2^{nd} week: 5 min., 2-3 times a week, at ˜0.6 of 450 mbars.

During the 3^{rd} week: 5 min., 2-3 times a week, at 0.9-1.0 of 450 mbars.

After the 3^{rd} week: 5 min., 2-3 limes a week, at 450 mbars.

After two months: 5 min., once a week, at 450 mbars to retain the effect.

As seen when comparing FIGS. 16B and 16A, there is a marked improvement in facial tone, after two months of treatment.

It will be appreciated that the vacuum treatment schedule hereinabove is merely an example, and other treatment schedules are similarly possible.

Referring further to the drawings, FIGS. 17A-17B are colored photographs of a 52-year old woman that underwent a vacuum treatment, in accordance with the present invention. FIG. 17A was taken prior to the treatment and FIG. 17B was taken after two months of treatment. The treatment schedule was as in FIGS. 16A-16B, hereinabove.

As seen when comparing FIGS. 17B and 17A, there is a marked improvement in facial tone, after two months of treatment.

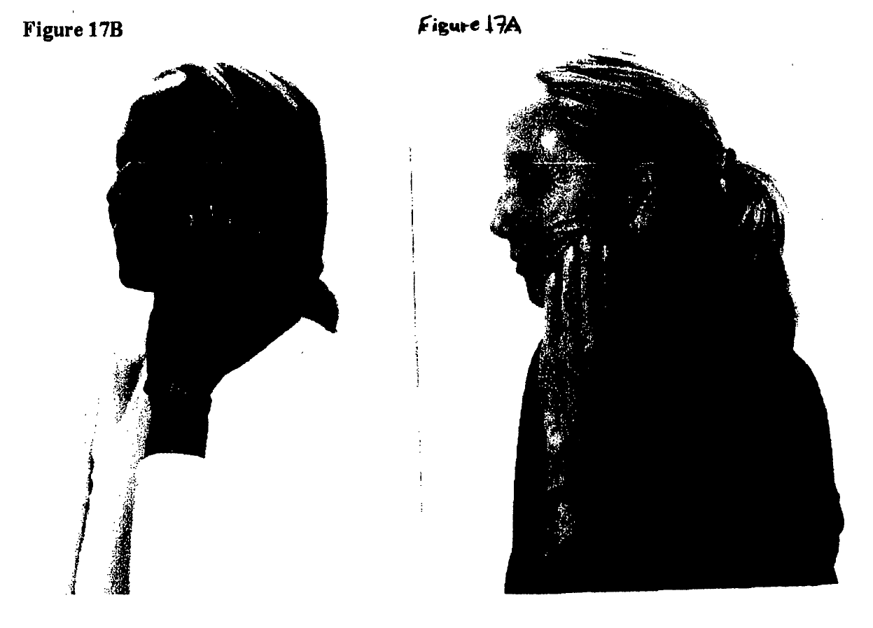

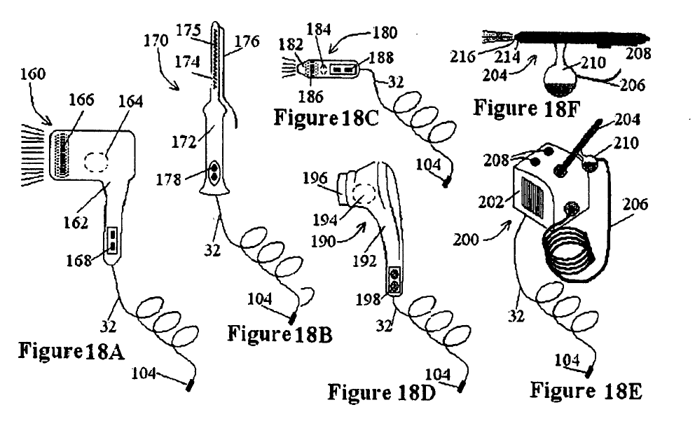

Referring further to the drawings, FIGS. 18A-18F schematically illustrate a plurality of devices for face, body and hair treatments, which may be included with system 100 (FIG. 14), in accordance with preferred embodiments of the present invention. The plurality of devices for face, body and hair treatments may selectively connect to power-and-control outlet 74, of power-and-control console 70, for example, via a coaxial plug 104, for power and signals. In accordance with the present invention, the plurality of devices for face, body and hair treatments may include, for example:

1. A hair blower 160 (FIG. 18A), which may include a body 162, a motor 164, and preferably also, at least one heating element 166 and one, and possibly two or more control switches 168, for example, for controlling the air flow rate and temperature. Preferably air flow rates are between 50 and 500 liters per minute, and preferably, between one and three levels of heating powers are provided, for example, 400 watts, 800 watts, and 1200 watts, or only 800 and 1200 watts, or only 800 watts, for example, by using between one and three heating elements 166, each of 400 watts. Alternatively, a combination of heating elements 166 of 300 or 200 watts may be used. It will be appreciated that other values may similarly be use. Hair blower 160 is adapted to selectively connect to power-and-control console 70 (FIG. 14), via power-and-control line 32 and plug 104. It will be appreciated that hair blower 160 may come with no heating elements 166. It will be appreciated that cooling diodes, for example as taught in conjunction with FIG. 7, may be used with hair blower 160, in place of, or in addition to heating elements 166.

In accordance with another preferred embodiment of the present invention, hair blower 160 may be shaped as a hat that is worn over the head. Again, one, and possibly two or more control switches, for example, for controlling the air flow rate and temperature, may be provided.

2. A hair curler 170 (FIG. 18B), which may include a handle 172, heating element 174, a hair gripping element 176, and one, and possibly two or more control switches 178, for example, an on/off switch and a temperature control switch. Hair curler 170 includes one and preferably several heating elements 175, for example of 200 or 400 watts each, thus providing the temperature control, via control switches 178. It will be appreciated that other values may similarly be use. Hair curler 170 is adapted to selectively connect to power-and-control console 70 (FIG. 14), via power-and-control line 32 and plug 104.

3. A nail dryer 180 (FIG. 18C), which may include a body 182, a motor 184, preferably also, at least one heating element 186 and one, and possibly two or more control switches 188, for example, for controlling the air flow rate and temperature. Preferably the air flow rate is between 50 and 500 liters per minute, and preferably one heating element 186 of 400 watts is used. Alternatively, two or more heating elements 186 may be used. However, it will be appreciated that other values may similarly be use. Nail dryer 180 is adapted to selectively connect to power-and-control control 70 (FIG. 14), via power-and-control line 32 and plug 104. It will be appreciated that nail dryer 180 may come with no heating element 186. It will be appreciated that cooling diodes, for example as taught in conjunction with FIG. 7, may be used with nail dryer 180, in place of, or in addition to heating element 186.

4. a face-and-body-cleaning-moisturizing-and-massaging device 190 (FIG. 18D), which may be fashioned, for example, as the DemanNew™, described in www.demanew.com, as downloaded on Apr. 9, 2003, or a similar device for cleaning and massaging of the face and (or) the body, as known. Face and body cleaning, moisturizing aid massaging device 190 may include a body 192, a preferably replaceable sponge 194, a motor 196, for producing the vibrating motion, and one, and possibly two or more control switches 198, for example, an on/off switch and a vibration speed switch. Face and body cleaning moisturizing, and massaging device 190 may be provided with various creams and lotions (not shown) for cleaning, moisturizing, and (or) nourishing the skin. The creams and lotions may include micro-crystals, for intensive cleaning of the skin. Face and body cleaning, moisturizing, and massaging device 190 is adapted to selectively connect to power-and-control console 70 (FIG. 14), via power-and-control line 32 and plug 104.

5. an airbrush system 200 (FIGS. 8E-18F), which may be fashioned, for example, as any out of the DINAIR® systems, described in www.dinair.com, as downloaded on Apr. 9, 2003, or a similar system as known. Airbrush system 200 may include a compressor unit 202, for housing a compressor, an airbrush 204, a dye canister 210, preferably mounted on airbrush 204, and an air hose 206, for providing communication between compressor unit 202 and airbrush 204, via dye canister 210. Preferably, dye canister 210 may be selectively removed from airbrush 204, for filling. Alternatively, dye canister 210 may be housed within compressor unit 202, next to the compressor. Airbrush 204 includes an air spout 214, with an opening 216. One, and possibly two or more control switches 208, which may be located on compressor unit 202 or on airbrush 204, may include a first control switch for controlling the air flow rate, and a second control switch for controlling the size of opening 216. Preferably the air flow rate is 500 liter per minute, but rates between 50 and 500 may be used. However, it will be appreciated that other values may similarly be use.

Preferably, airbrush system 200 may be used for eye makeup, facial makeup, body painting, tanning, tattoo-like applications, nail drawings, hair dying, and other color applications to the face and body, as known. Furthermore, airbrush system 200 may be a professional system, used, for example, in TV and movie studios, or a home system. Airbrush system 200 may be provided with a plurality of air spouts 214, for controlling the spray imprint. Airbrush system 200 is adapted to selectively connect to power-and-control console 70 (FIG. 14), via power-and-control line 32 and plug 104.

It will be appreciated that any of the devices and systems described hereinabove, in conjunction with FIGS. 18A-18F, may come with no control switch, and their operation will be controlled by the insertion of their plug 104 into receptor 102 (FIG. 14).

It will be appreciated that other devices for ace, body and hair treatments may similarly be included with system 100, for receiving power from system 100, for example, other massage systems, or other erection implements.

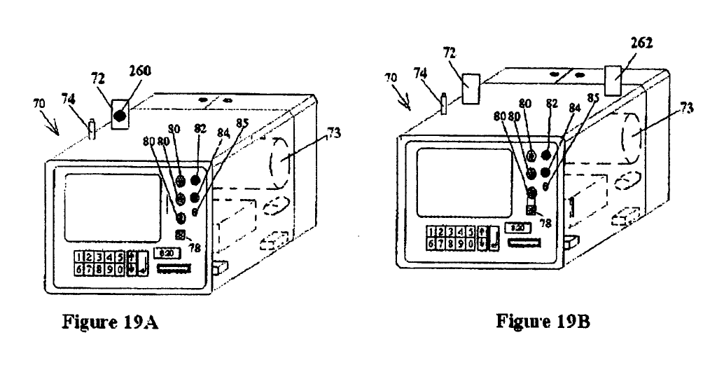

Referring further to the drawings, FIGS. 19A-19B schematically illustrate power-and-control console 70, in accordance with other preferred embodiments of the present invention. In FIG. 19A, a switch 260 is provided for selectively converting vacuum source 73 to a compressor 73. Vacuum outlet 72 then becomes air outlet 72.

Alternatively, as seen in FIG. 19B, an exhaust 262 of vacuum source 73 may be used as an air outlet 262.

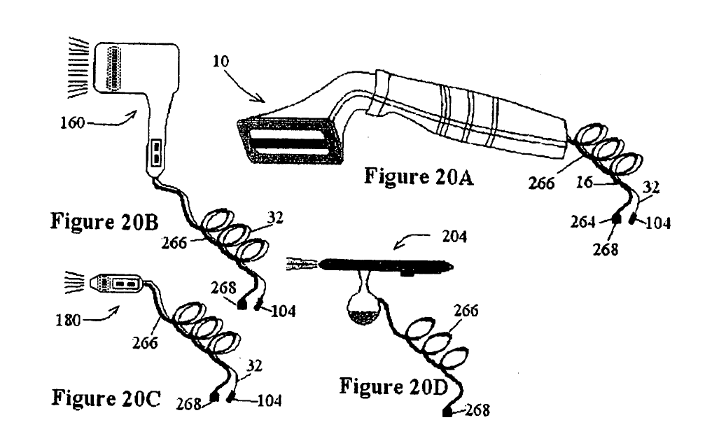

Referring further to the drawings, FIGS. 20A-20D schematically illustrate a plurality of devices for face, body and hair treatments, which may be included with system 100 (FIG. 14), and may selectively connect to power-and-control console 70.

As seen in FIG. 20A, device 10 is adapted to selectively connect to power-and-control outlet 74, for example, via power-and-control line 32 and preferably coaxial plug 104, and adapted to connect to vacuum outlet 72, via vacuum hose 16 and vacuum connector 264.

Alternatively, in accordance with the present embodiment, vacuum line 16 may double as airline 266, with air connector 268, for receiving air from air outlet 262 (FIG. 19B). Thus device 10 may operate as a dryer of an air blower, for example as a nail dryer or a hair blower. Various heating elements, for example, heating diodes, may be used with device 10, when operating as an air blower, for example, for drying.

As seen in FIG. 20B, hair blower 160 need not include motor 164 (FIG. 18A). Rather, it is adapted to selectively connect to air outlet 72 (FIG. 19A) or air outlet 262 (FIG. 19B), via airline 266 and air connector 268. Additionally, hair blower 160 is adapted to selectively connect to power-and control outlet 74, for example, via power-and-control line 32 and coaxial plug 104.

As seen in FIG. 20C, nail dryer 180 need not include motor 184 (FIG. 18C). Rather, it is adapted to selectively connect to air outlet 72 (FIG. 19A) or air outlet 262 (FIG. 19B), via airline 266 and air connector 268. Additionally, nail dryer 180 is adapted to selectively connect to power-and-control outlet 74, for example, via power-and-control line 32 and coaxial plug 104.

As seen in FIG. 20D, airbrush 204 is adapted to selectively connect to air outlet 72 (FIG. 19A) or air outlet 262 (FIG. 19B), via airline 266 and air connector 268.

It will be appreciated that other devices and systems may be connected to any one of power-and-control outlet 74, vacuum outlet 72 and air outlet 72 (FIG. 19A) or air outlet 262 (FIG. 199B). It will be further appreciated that in accordance with the embodiments of FIGS. 19A and 19B, vacuum outlets 72 or 262 and air outlet 72 may not be used simultaneously.

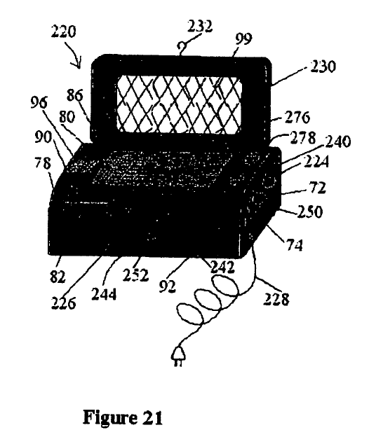

Referring further to the drawings, FIG. 21 schematically illustrates a face-and-body-treatment system 220, arranged as a self-contained system, in a carrying case, in accordance with a preferred embodiment of the present invention.

Accordingly, system 220 may be arranged as a laptop, preferably, with a storage compartment, for example, as a 3-layer suitcase.

A first layer 230 may be operative as a cover, and preferably include mirror 99.

A second layer 240 may be operative as power-d-control console 70, generally as described hereinabove, in conjunction with FIG. 13A, and may be further adapted to latch with first layer 230, via a complimentary latch system formed of latch elements 232 of layer 230 and 242 of layer 240.

A third layer 250 may be operative as a storage box, for example, to any of the devices, spouts, and systems described hereinabove, in conjunction with FIGS. 1A-12 and 18A-18F. Third layer 250 may be adapted to latch with second layer 240, via a complimentary latch system, formed of latch elements 244 of layer 240 and 252 of layer 250.

A carrying handle 226 may also be provided. A power line 228 connects system 220 to the grid.

Preferably, power-and-control console 70, of second layer 240, provides vacuum to vacuum hose 16 (FIG. 1A), via vacuum outlet 72, and power to power-and-control line 32 (FIG. 1A, 18A-18E), via power-and-control outlet 74. Additionally, power-and-control console 70 preferably includes on/off control knob 78, light indicator 82, clock 96, and interactive display panel 86, which may display various buttons 80 and the feature or schedule that is selected.

Read/write storage system 90 such as a diskette drive, a CD drive, or a mini CD drive may be used for storing or reading specific schedules.

Preferably, the length of system 220 is between about 20 and about 60 cm, the width is between about 15 and about 40 cm, and the height is between about 15 and about 25 cm. The weight of system 220 may be between about 0.5 Kg. and about 7 Kg. It will be appreciated that other dimensions and weights, which may be larger or smaller, are also possible and are within the scope of the present invention.

In accordance with the present embodiment, power-and-control console 70 may include a compressor 202 (FIG. 18E), in addition to vacuum source 73 (FIG. 13A). Thus, vacuum outlet 72 and air outlet 224 may be operative simultaneously.

It will be appreciated that the devices of FIGS. 20A-20D may be selectively connected to any one of, vacuum outlet 72, air outlet 224, and power-and-control outlet 74.

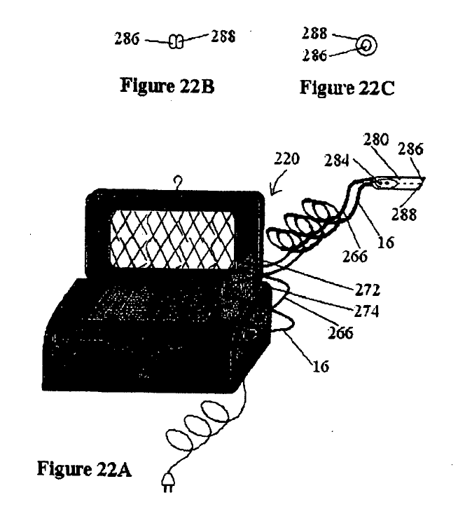

Referring further to the drawings, FIGS. 22A-22C schematically illustrate system 220 for face and body treatment, adapted for sandblasting peeling in accordance with another preferred embodiment of the present invention.

As seen in FIG. 22A, system 220 may be used also for face and body sandblasting, which is a form of cleansing or peeling, by using vacuum outlet 72 and air outlet 224 simultaneously. The use of sandblasting for cleansing and peeling is termed herein, sandblasting peeling.

Accordingly, a first jar 272 of clean crystals is mounted on a depression 276 (FIG. 21), while a second, empty jar 274, adapted to receive the used crystals, is mounted on a depression 278.

Air line 266, flowing through first jar 272 carries the clean crystals to an outlet nozzle 286 of a sandblasting spout 280, while vacuum hose 16, which enters and exits second jar 274 sucks skin debris and crystals via inlet nozzle 288 of sandblasting spout 280.

It will be appreciated that dung sandblasting, vacuum outlet 72 and air outlet 224 operate simultaneously.

FIG. 22B illustrates a first arrangement of outlet nozzle 286 and inlet nozzle 288, wherein the two nozzles are side by side.

FIG. 22C illustrates a second arrangement of outlet nozzle 286 and inlet nozzle 288, wherein the two nozzles are concentric.

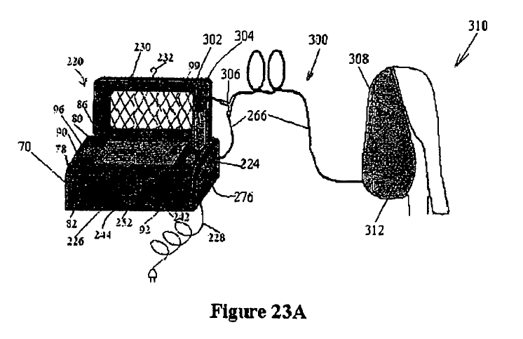

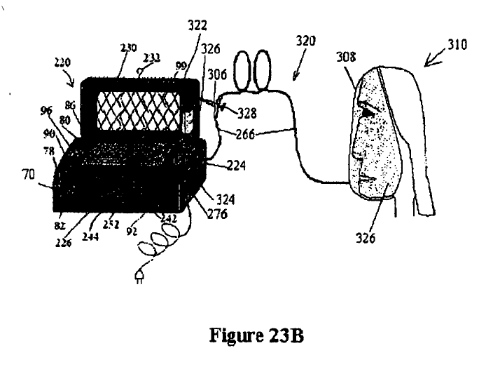

Referring further to the drawings, FIG. 23A schematically illustrates an oxygen therapy device 300 in accordance with a preferred embodiment of the present invention. Oxygen therapy device 300 preferably includes an oxygen canister 302, which includes liquefied oxygen, preferably mixed with an aromatic oil, which serves as a carrier, for penetrating the tissue and living cells.

In essence, the oxygen molecule may not penetrate a living cell, but when bound to a carrier, such penetration is facilitated. Oils that may be used as carriers are, for example, grape seed oil, safflower oil, or sweet almond oil. Additionally or alternatively, other oils or a combination of oils may be used.

Canister 302 may be arranged, for example, in depression 276. Preferably, canister 302 contains sufficient oxygen for a single treatment of about 15 minutes, at an oxygen concentration of between about 80% and about 90%, in the air.

A valve 304, mounted on canister 302, may be used to control the flow of oxygen and aromatic oil firm the canister. Additionally, a connector 306 may be used to introduce the oxygen and aromatic oil to airline 266, which receives air from air outlet 224.

A mask 308 is provided, which a user 310 may place on his or her face, for receiving oxygen enriched air. The oxygen is breathed in, and may also penetrate facial tissue directly.

Preferably, canister 302 is adapted to provide about 15 minutes of oxygen enriched air, at a concentration of between 20 and 99 percent oxygen, preferably, between 80 and 95 percent. It will be appreciated that other values may be used. The aromatic oils may further be selected for their other properties for example, cell renewal, GI track infection suppression, pain relief, mood enhancer, and the like.

In accordance with the present invention, an oil, a cream, or an aromatic oil may be applied to the face, prior to applying mask 308, in addition to, or in place of the aromatic oil of canister 302. The oil, cream, or aromatic oil may be, for example, Johnson's Baby oil, another oil, facial cream, or aromatic oil, as known. Again, the aromatic oils may further be selected for their other properties for example, cell renewal, GI track infection suppression, pain relief, mood enhancer, and the like.

Alternatively a spout 12, for example, as taught in conjunction with FIG. 2A, hereinabove, may be used for oxygen therapy, in place of mask 308.

In accordance with the present invention, oxygen therapy may be used for cell renewal, improved metabolism, and body cleansing.

Alternatively, device 300 may be an ozone therapy device 300, and canister 302 may contain liquefied ozone.

Referring further to the drawings, FIG. 23B schematically illustrates a steam therapy device 320 in accordance with a preferred embodiment of the present invention. Steam therapy device 320 preferably includes a boiling unit 322, having a heater 324. Steam therapy device 320 may be arranged in depression 276, which includes a heater 324, for producing steam 326.

Steam, and possibly also mist, may flow from boiling unit 322 and join airline 266, via connector 306. A valve 328 may be used to regulate the mixture of steam and mist on one hand, and air, on the other. Preferably, airline 266 receives air from air outlet 224.

User 310 may thus place mask 308 over his or her face and breath air, which is highly enriched with steam or mist 326. Steam system 320 may be used, for example, when user 310 has a cold, or in advance of facial cleansing or in advance of an application of certain creams, since the steam is operative to open facial pores.

Alternatively a spout 12, for example, as taught in conjunction with FIG. 2A, hereinabove, may be used for steam therapy, in place of mask 308.

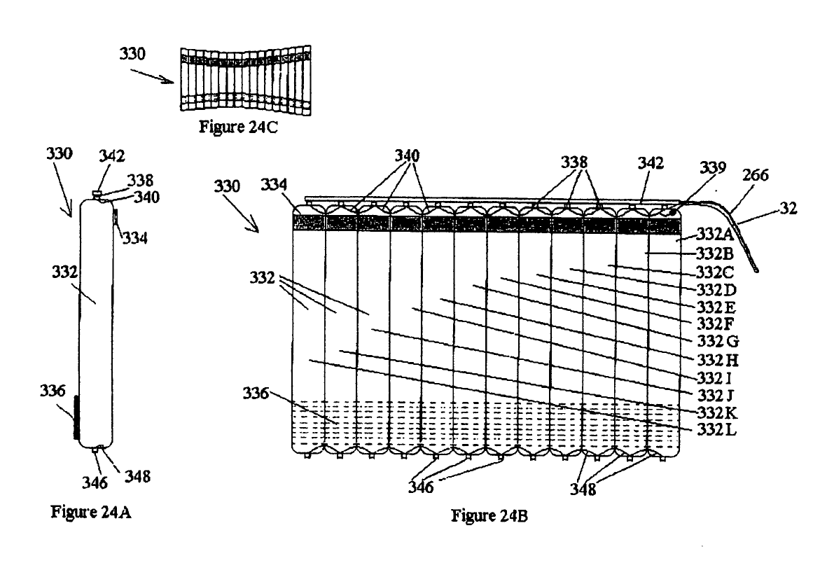

Referring further to the drawings, FIGS. 24A-24C schematically illustrate side and front views of a for lymphatic massage device 330, in accordance with a preferred embodiment of the present invention. The purpose of lymphatic massage device 330 is to provide a low-power, gentle massage that reduces the concentration of interstitial fluids in the tissue.

Preferably, lymphatic massage device 330 includes a series of pockets 332, such as 332A-332L, each having a solenoid valve 338, in communication with airline 266. Preferably, gentle massage is provided, by cyclic inflation of the pockets, one after the other, so that each, in turn, provides pressure, for example, on a limb, such as an arm or a leg, generating a gentle pressure wave on the limb. Alternatively, lymphatic massage device 330 may be used on the belly. During operation, solenoid valve 338 of pocket 332A opens first, filling up pocket 332A to provide pressure onto the limb. The solenoid valve of pocket 332A then closes, but that of pocket 332B opens up, and while the pressure from pocket 332A is reduced, via opening 346, that from pocket 332B is builds up.

A power-and-signal-cable 340 provides power and communication between solenoid valves 338 and power-and-control console 70 of system 20 (FIG. 22 or 23), via power-and-control cable 32. A pressure sensor 339, in communication with power and signal cable 340, may be used, in at least one pocket 332, for determining the extent of inflation. One sensor 339 may be sufficient, where the pockets are similar in size and construction. It will be appreciated that more than one sensor 339 may be used.

Additionally, a second series of openings 346 is provided. Solenoid valves and a power and signal cable 348 may be provided for them. Alternatively, these are mere openings, for example, of 2-5 mm in diameter. It will be appreciated that other values may similarly be used. Openings 346 need not have valves because generally the rate of inflow will be much greater than the rate of outflow.

Preferably, peak absolute pressure for each pocket may be set at between 1.5 and 2.0 atmospheres, for example, 1.8 atmospheres, at sea level, based on the reading of pressure sensor 339.

Velcro strips 334 and 336 are used for wrapping lymphatic massage device 330 around a limb, such as an arm, an ankle, or a leg. Lymphatic massage system 330 may extend through a portion of the limb or the whole limb.

It will be appreciated that pockets 332 need not be identical. Rather, they may be constructed so as to accommodate the geometry of a specific limb. For example, FIG. 24C illustrates lymphatic massage device 330 designed for a leg, from the ankle to the thigh. Where pockets 332 are not identical, pressure sensors 339 may be used in each pocket.

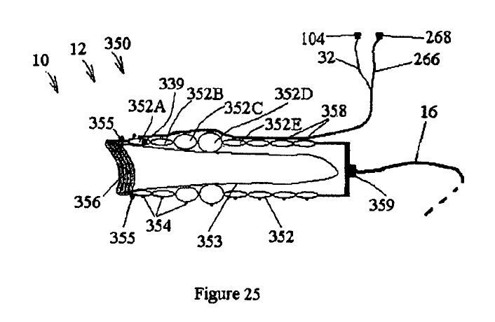

Referring fiber to the drawings, FIG. 25 illustrates an erection massage device 350, in accordance with a preferred embodiment of the present invention. To some extent, erection massage device 350 is similar to erection implement 150, described hereinabove, in conjunction with FIG. 12, but erection massage device 350 includes a massage system, similar to that of lymphatic massage device 330 of FIGS. 24A-25C.

Accordingly, erection massage device 350 includes a soft, flexible hose 352, having a plurality of pockets, such as 325A, 325B, 325C, 325D, and 325E. Flexible hose 352 connects to vacuum hose 16, via a connector 319. Additionally, flexible hose 352 includes a mouthpiece 356, adapted to form a seal with the body. Preferably, mouthpiece 356 is soft and flexible, formed for example, a an accordion, so as to adapt to the body shape.

In order to prevent fluids from reaching vacuum hose 16, a condom 353 may be used, inserted into erection implement 350, folded over the edges of mouthpiece 356, and held, for example, with a rubber band 355.

Airline 266, and power-and-control cable 32, in communication with pockets 325A, 325B, 325C, 325D, and 325E, via solenoid valves 354, provide a gentle massage, by cyclic inflation of the pockets, one after the other, so as to provide a gentle pressure wave on the penis. Preferably, peak absolute pressure for each pocket may be set at between 1.5 and 2.0 atmospheres, for example, 1.8 atmospheres, at sea level, based on the readings of pressure sensor 339, of which, at least one, and possibly several may be used.

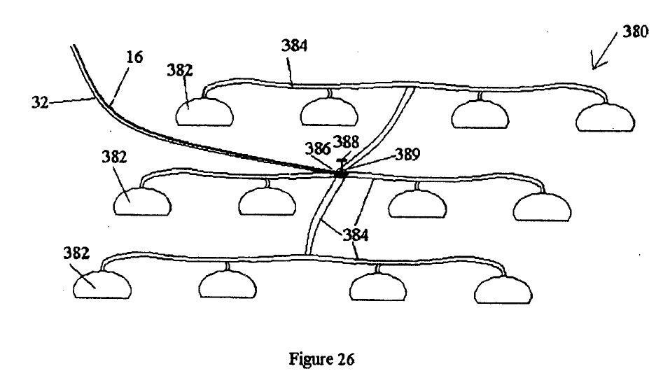

Referring further to the drawings, FIG. 26 schematically illustrates a cupping device 380, in accordance with a preferred embodiment of thc present invention.

Cupping device 380 includes a plurality of cups 382, connected by a network of vacuum hoses 384, which come together at a junction 386, and connect with vacuum hose 16 and power-and-control cable 32. Junction 386 may further include a valve 388, preferably a solenoid valve, which may further include a pressure sensor 389, for controlling the vacuum in airlines 384. Alternatively, each cup 382 may be directly connected to vacuum hose 16, and to power-and-control cable 32, and may possibly include a valve and possibly also a pressure sensor.

Cupping device 380 is preferably intended for the treatment of mascular-skeletal pain, for example, by placing plurality of cups 382 on the back of a user (not shown). It is generally believed that the application of a mild vacuum, for example, −50 to −500 bars, by cups, causes an enlargement of the peripheral blood capillaries, and leads to relief of mascular-skeletal pain. Thus plurality of cups 382 is adapted for the application of a mild vacuum, for example, −50 to −500 bars. It will be appreciated that other values are also possible.

In accordance with the present invention, cups 382 may further include any one of the features described hereinabove, in connection with FIGS. 3A-8, such as an infrared light treatment, UV light treatment, LLLT, or electrostimulation therapy.

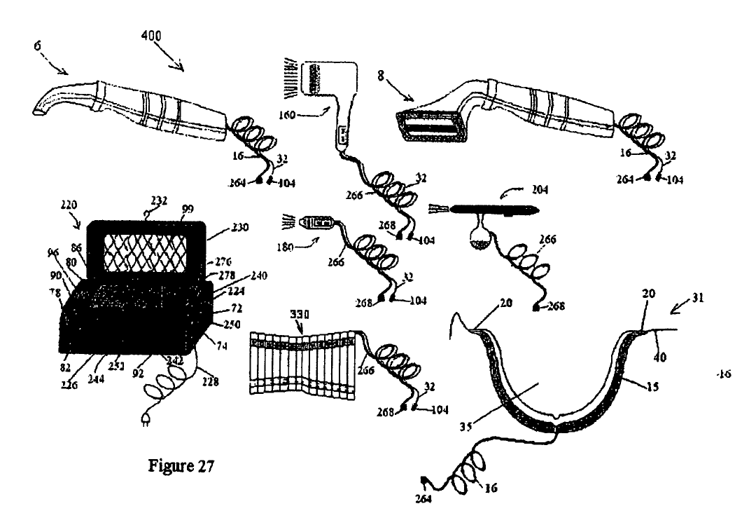

Referring further to the drawings, FIG. 27 schematically illustrates a face-and-body-treatment system 400 for home use of the woman. System 400 may include any one of, and preferably a plurality of the devices taught in conjunction with the drawings hereinabove, preferably excluding the erection implements of FIGS. 12 and 25. Preferably face-and-body-treatment system 400 for home use of the woman is designed and colored in a manner that is likely to appeal to women. Face-and-body-treatment system 400 for home use of the woman may be used by the general female community, as well as by women of the performing arts.

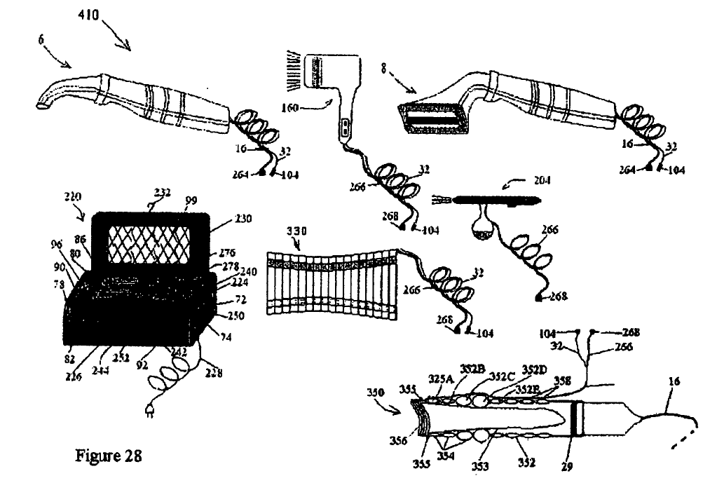

Referring further to the drawings, FIG. 28 schematically illustrates a face-and-body-treatment system 410 for home use of the man. System 410 may include any one of, and preferably a plurality of the devices taught in conjunction with the drawings hereinabove, preferably excluding the breast firming devices of FIGS. 2D-2F. Preferably face-and-body-treatment system 410 for home use of the man is designed and colored in a manner that is likely to appeal to men. Face-and-body-treatment system 410 for home use of the man is designed for the general male community, people of the performing arts, the homosexual community and drug queens, and may be colored and aesthetically designed specifically for each community.

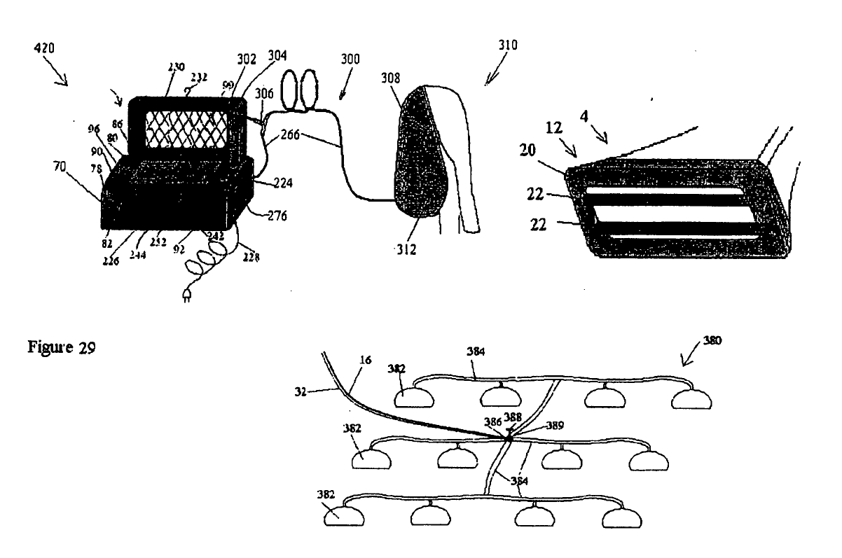

Referring further to the drawings, FIG. 29 schematically illustrates a face and-body-treatment system 420 for clinics. A clinic version may include any one of, and preferably a plurality of the devices taught in conjunction with the drawings hereinabove, preferably including devices that require assistance for their application, for example, cupping device 380 or double-roller rectangular spout 4 for applying suction massage therapy to the body, in addition the other devices taught in conjunction with the drawings hereinabove.

It will be appreciated that the face and body systems of the present invention may be divided to:

a first-generation system, which includes a suction pump, and which is described in conjunction with FIGS. 1A-18F and FIG. 26:

a second-generation system, which includes a suction and air-blowing pump, and which is described in conjunction with FIGS. 19A-20D and

a third-generation system, which includes a pump and a compressor, for suction and for air blowing, for example, as described in conjunction with FIGS. 21 and 22A.

It will be appreciated that the systems, which are described in conjunction with FIGS. 22-25, and 27-29 may be second or third generation systems.

It will be appreciated that an oil or a cream, which may be for example, a baby oil, a body lotion, a hand cream, a facial cream, a facial tonic, a collagen cream, an aromatic oil, or an aromatic cream may be used together the system of the present invention. Some oils and (or) creams, which may be used in conjunction with the present invention, are olive oil, jojoba oil, shea butter, avocado oil, peach-kernel oil, pumpkin-seed oil, Saint Johns Wort oil, safflower oil, almond oil, grape-seed oil, and other oils and combinations of oils as known.

In accordance with another preferred embodiment of the present invention, the user may buy a system of the present invention with a limited number of attachments. Additionally, the user may upgrade his system by buying additional attachments at a later time.

It will be appreciated that power-and-control line 32 may be replaced by dedicated power and control lines, each with an individual plug, replacing coaxial plug 104. It will be appreciated that other connection a known may he used, in place of coaxial plug 104.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

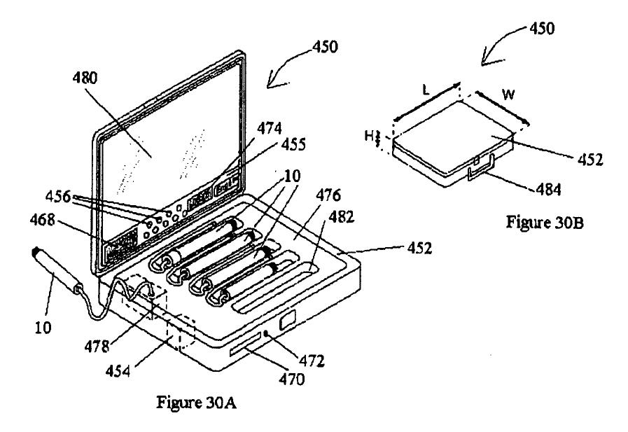

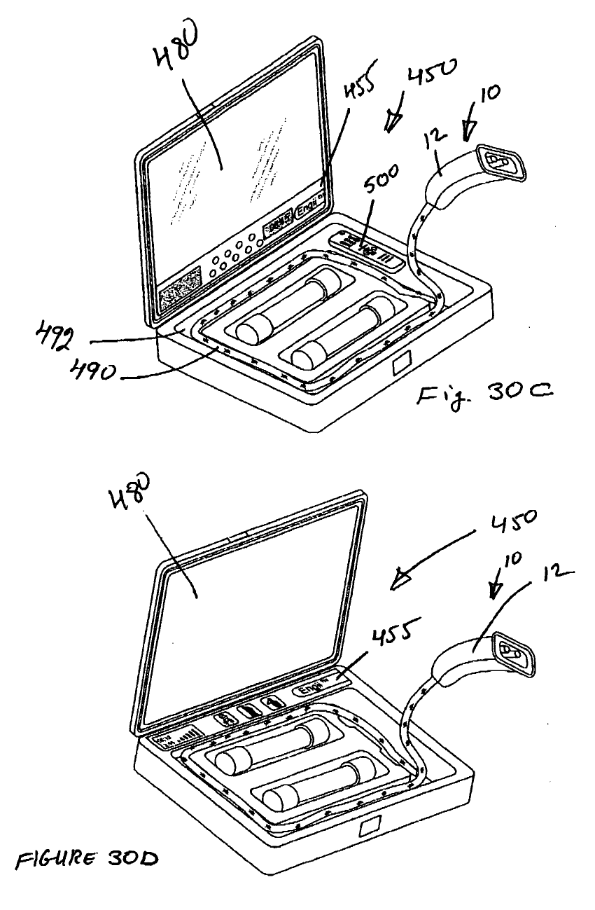

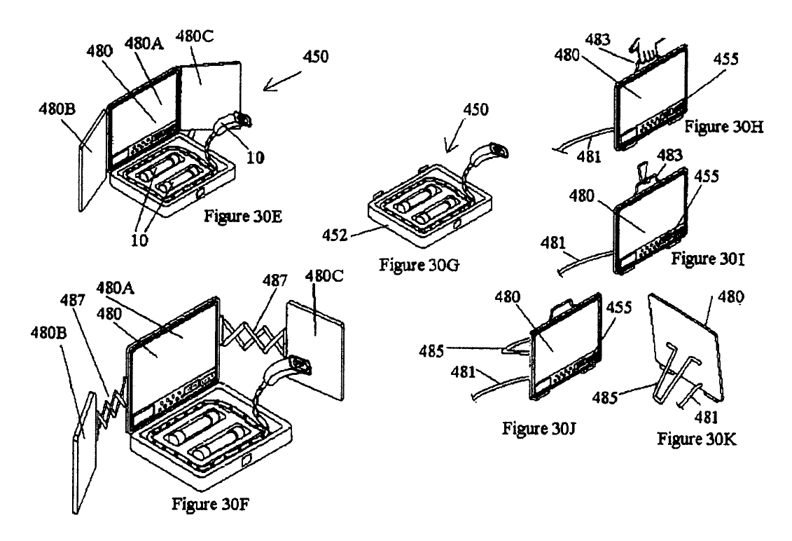

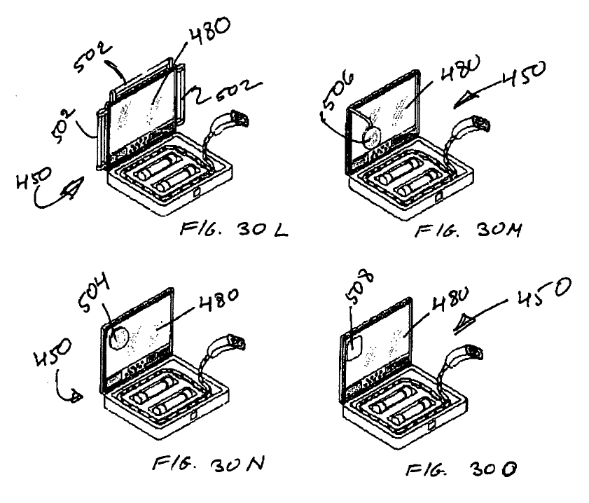

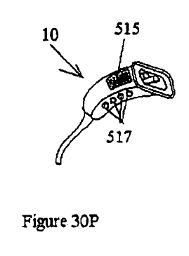

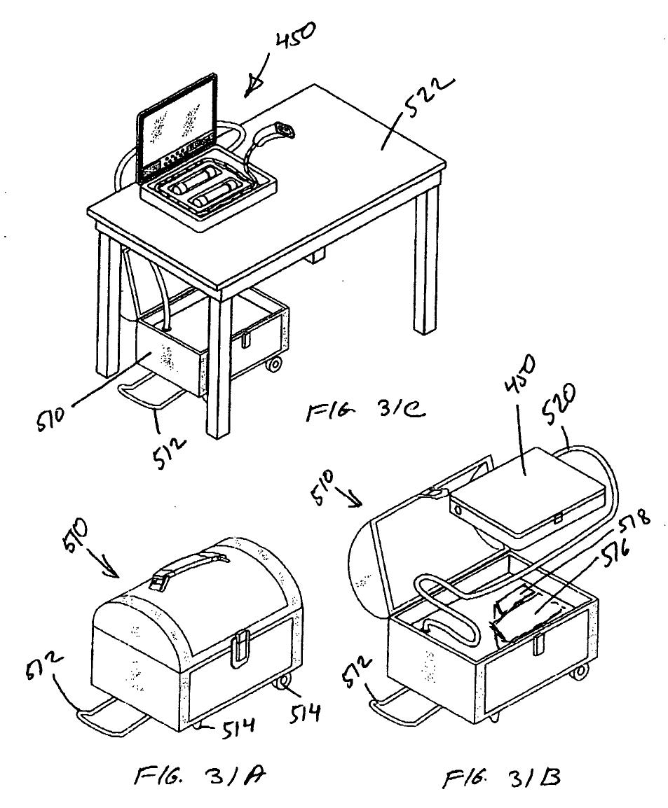

Referring further to the drawings, FIGS. 30A-30P schematically illustrate a face-and-body-treatment, laptop-like kit 450, in accordance with a preferred embodiment of the present invention.

Preferably, face-and-body-treatment, laptop-like kit 450 includes a carrying case 452, and a built-in computerized device 454. Additionally, face-and-body-treatment, laptop-like kit 450 includes a control panel 455, at least one, and preferably several control keys 456 and a display screen 468. A read/write device 470, controlled by a key 472 is preferably also provided.

An important feature of face-and-body-treatment, laptop-like kit 450 is a mirror 480, for self-application of various treatments.

An inner space 476 of face-and-body-treatment, laptop-like kit 450 includes depressions 482, arranged to receive at least one, and preferably several devices 10 for different treatment modes.

The treatment devices, associated with face-and-body-treatment, laptop-like kit 450 include, for example, devices for applying suction treatment, suction, macro massage treatment, cupping treatment, warming light treatment, white-light halogen treatment, white-light fluorescent treatment, far infrared light treatment, medium infrared light treatment, near infrared light treatment, UV light treatment, Low Level Laser Treatment (LLLT). RF treatment, ultrasound treatment, pulsating magnetic field treatment, constant magnetic field treatment, electrostimulation treatment, microcurrent treatment, cooling-diode treatment, warming-diode treatment, mechanical epilation, photoepilation, ultrasound epilation, hair drying, electric hair setting, rotating-hair-brush hair rolling, nail drying, oxygen treatment, oxygen peeling, ozone treatment, steam treatment, sandblasting peeling face-and-body-cleaning-moisturizing-and-massaging treatment, lymphatic massage treatment, and air-blush makeup application.

Additionally, each device may be designed for two or more modes of treatment.

Face-and-body-treatment, laptop-like kit 450 may further include a clock 474 or a timer, for timing the treatment.

A battery 478 is preferably rechargeable. Preferably, computerized device 454 may provide operating instructions for various devices, for example, as movies.

These may be stored in its memory, or read firm a removable memory device, via read/write device 470.

Additionally, computerized device 454 may maintain a treatment log, preferably, by user name, recording the various treatment modes, their times, durations, and operational parameters, for follow-up of a treatment program.

FIG. 30B illustrates face-and-body-treatment, laptop-like kit 450 when closed. A handle 484 is provided for easy carrying. Length L, width W and height H of sizes that make face-and-body-treatment, laptop-like kit 450 easy to carry. For example, L may be between 20 and 60 cm, W may be between 15 and 40 cm, and W may be about 10-25 cm. It will be appreciated that other dimensions may similarly be used. Preferably, the weight of face-and-body-treatment, laptop-like kit 450 may be between 0.5 and 7 kg, although other weights are also possible.

As seen in FIG. 30C, device 10 may include suction spout 12, for example, as taught in conjunction with FIGS. 1A-1D, hereinbelow, having a coiled, flexible hose 490, arranged within a duct 492. Preferably, hose 490 has a length that exactly fits within duct 490 of the inner space of face-and-body-treatment, laptop-like kit 450.

Additionally, face-and-body-treatment, laptop-like kit 450 may further include a remote control 500.

As seen in FIG. 30C, control panel 455 may be located on mirror panel 480. Alternatively, as seen in FIG. 30D, may be located elsewhere on body 452.

As seen in FIG. 30E, mirror 480 may include a central portion 480A, and side flaps 480B and 480C, for providing viewing from different angles.

As seen in FIG. 30F, side flaps 480B and 480C may be extended from central portion 480A, via extendable arms 487.

As seen in FIGS. 30G-30K, mirror 480 may be removed from face and-body-treatment, laptop-like kit 450, and held or hung by a hanger 483, or lean on a stand 485. Control panel 455 may remain on mirror 480, connected to body 452 via a cable 481.

As seen in FIGS. 30L-30O, mirror 480 may further include a lighting system 502, a magnifying portion 504, or a magnifying glass 506.

A second display screen 508 may also be provided, for example, on mirror 480, for a larger display, for example, in order to provide opting instructions.

FIG. 30P illustrates a device 10 on which some control features have been integrated, for example, a display screen 515 and control keys 517.

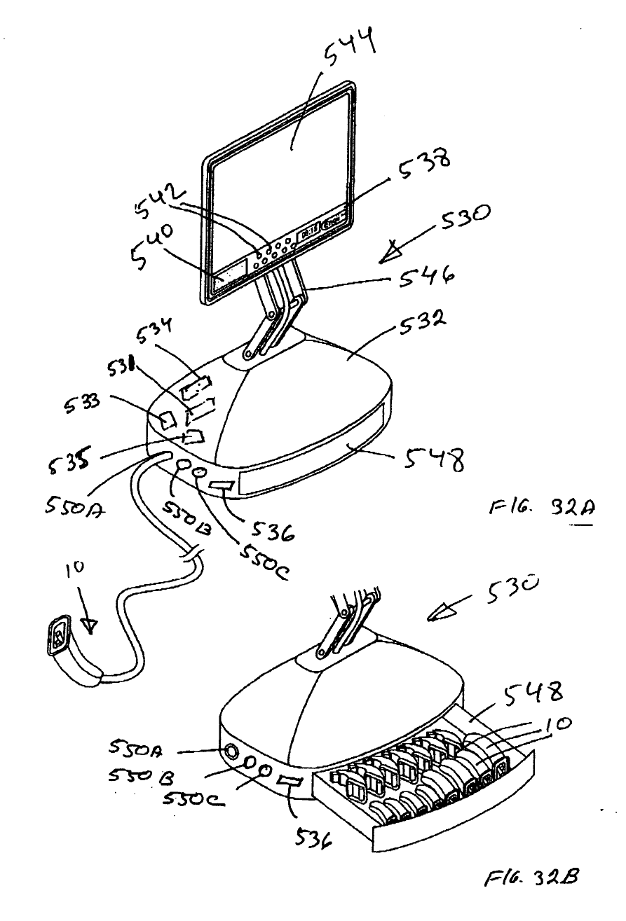

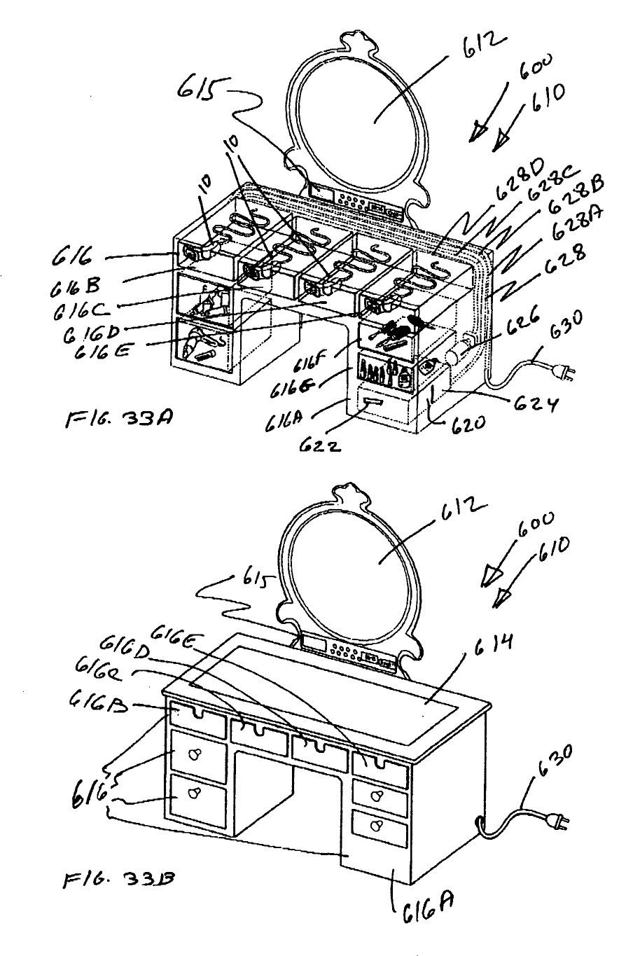

Referring further to the drawings, FIGS. 31A-31C schematically illustrate face-and-body-treatment, laptop-like kit 450, integrated with a larger trunk 510, in accordance with the present invention. Preferably, trunk 510 has wheels 514 and a handle 512. Trunk 510 may be used to house a vacuum pump 516 and (or) a compressor 518, for providing suction or air flow to face-and-body-treatment, laptop-like kit 450, for example, via a hose 520, also arranged within trunk 510.

For operation, face-and-body-treatment, laptop-like kit 450 may be placed on a table 522 or dresser 522, while trunk 510 with vacuum pump 516 and (or) compressor 518 may remain on the floor, nearby.

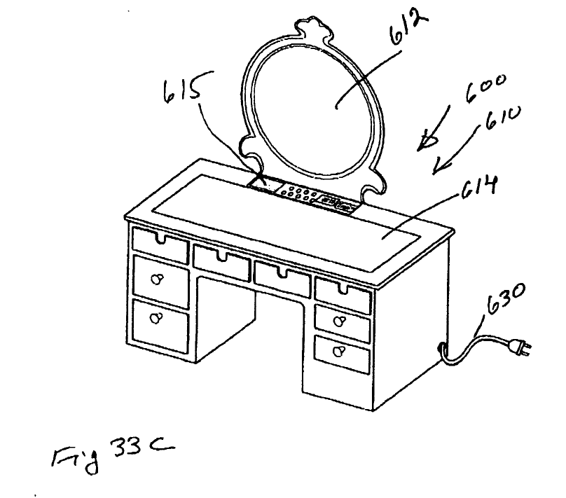

Referring further to the drawings, FIGS. 32A-32B schematically illustrate a face-and-body-treatment kit 530, in accordance with another preferred embodiment of the present invention. Face-and-body-treatment kit 530 has a body 532, which houses a computerized device 534, a pump 531, a preferably rechargeable battery 533, and possibly also a compressor 535. A read/write drive 536 enables the use of a removable memory device, such as a CD, or a diskette. A control panel 538, preferably, having a display so 540, and control keys 542, may be positioned with a mirror 544, on a retractable stand 546. A drawer 548, which issues from body 532, contains devices 10.

Socket 550A, 550B, and 550C, respectively, provide communication between one of devices 10 and pump 531, battery 533, and possibly also compressor 535, as well as with computerized device 534, which communicates with them all of the above.

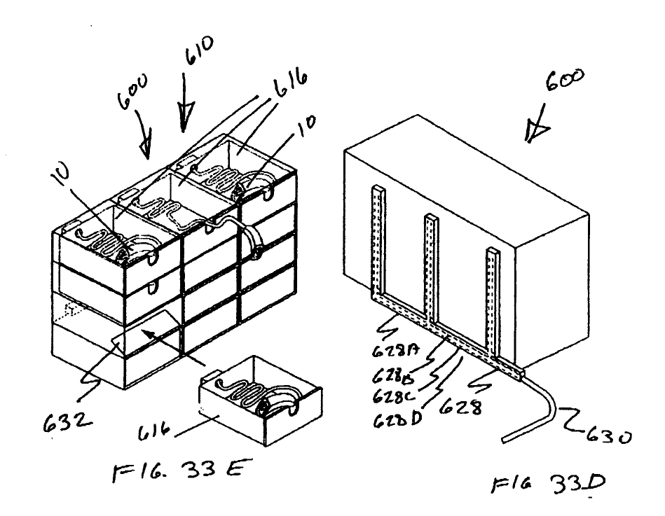

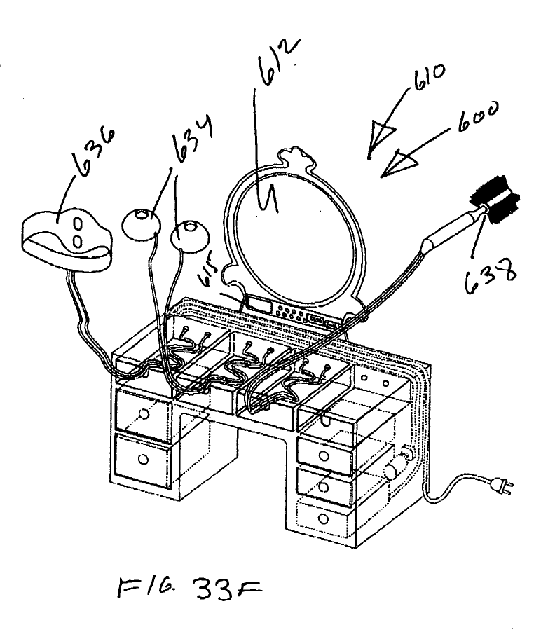

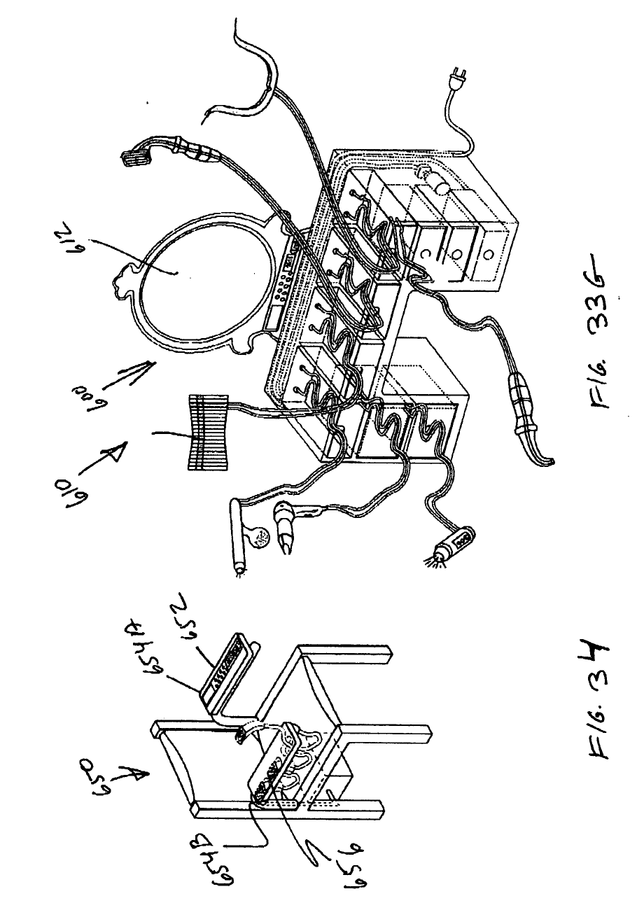

Referring further to the drawings, FIGS. 33A-33G schematically illustrate a dresser 600, for housing a face-and-body-treatment system 610, in accordance with another preferred embodiment of the present invention. Dresser 600 includes a mirror 612, a top 614, and drawers and (or) cabinets 616.

Preferably, a cabinet portion 616A houses a computerized device 620, preferably, having a read/write drive 622, a pump 624, and a compressor 626. A power cable 630 connects dresser 600 to the grid. Lines 628, comprising lines 628A, 628B, 628C, and 628D, provide vacuum from pump 624, airflow from compressor 626, power from the grid, and signals from computerized device 620, respectively, along dresser 600.

A control panel 615 is preferably included, preferably located on mirror 612 (FIG. 33B), or on top 614 (FIG. 33C). Alternatively it may be connected elsewhere on dresser 600.

Preferably, a top row of drawers comprising drawers 616b, 616C, 616D, and 616E are dedicated for devices 10, and ech includes an internal socket for connecting a specific device 10 with lines 628. Other drawers may similarly be used for devices 10. Additionally or alternatively they may be used for creams, hair brushes, makeup kits, and the like, as shown in drawers, 616F and 616G.

FIG. 33D illustrates a back side of dresser 600, showing lines 628, forming a grid along its back.

In accordance with an embodiment of the present invention, dresser 600 may have dedicated drawers 616 for specific devices 10, and may come with some drawers, and some spaces that are empty, covered by a flap 632, as seen in FIG. 33E. When the specific device 10 is purchased, the flap is replaced by a dedicated drawer 616. Alternatively, dresser 600 may include ordinary drawers, in place of the dedicated drawers that were not purchased.

FIGS. 33F and 33G further illustrate dresser 600 and some devices of system 610 for face and body treatment, which may be purchased with dresser 600, in accordance with the present invention. These may include for example, an air brush, a hair dryer, a device for lymphatic message, as was illustrated hereinbelow, in conjunction with FIGS. 27-29. Additionally, other devices, for example, electrostimulation cups 634 for breast finning, an electrostimulating belt 636 for weight loss, and a rotating hair brush 638 may be included.

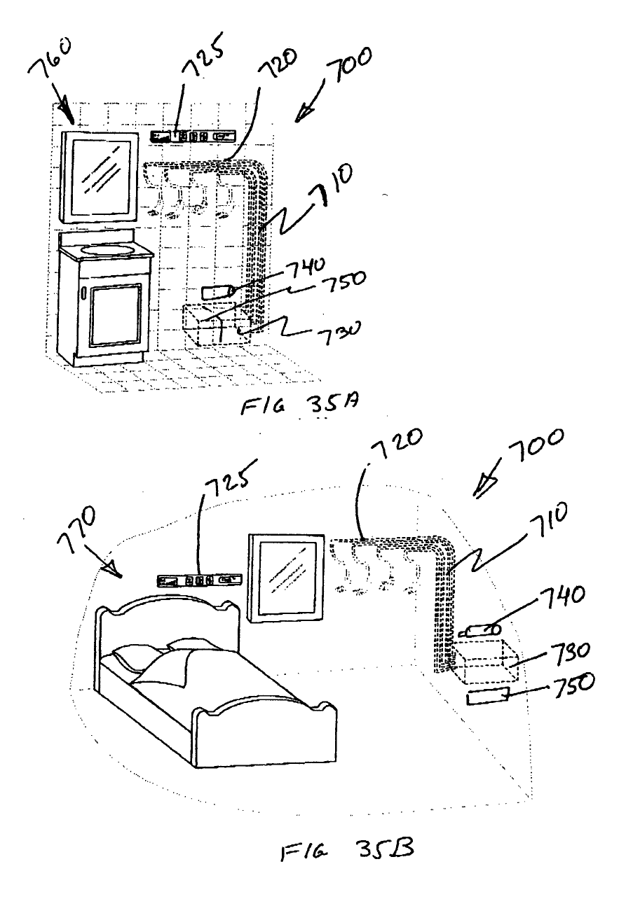

Referring further to the drawings, FIG. 34 illustrates a face-and-body-treatment-system 650, built into a chair, in accordance with the present invention. An arm rest 654A includes a control panel 652, and another armrest 654B includes a set of devices 10, as if on a rack 656.

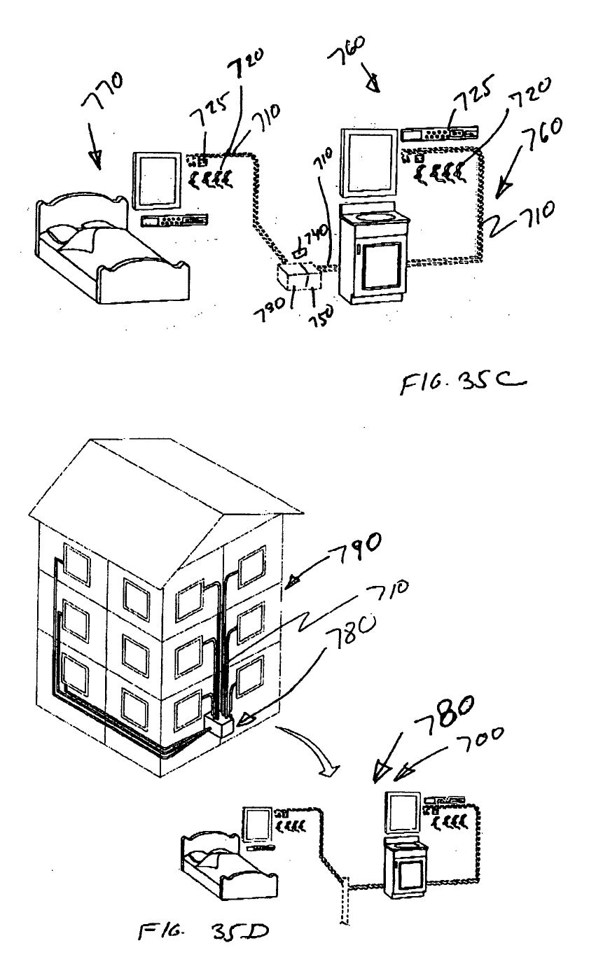

Referring further to the drawings, FIGS. 35A-35D schematically illustrate built-in systems 700 for face and body treatments, in accordance with the present invention. When the systems are built in, lines 710, a pump 730, a compressor 740, and a computer 750 may be built into the walls, and devices 10 may be hung on a rack 720, near a control panel 725.

The system may be built in a bathroom 760 (FIG. 35A), a bedroom 770, (FIG. 35B), both bathroom 760 and bedroom 770 (FIG. 35C). Additionally, or alternatively, the system may be central system 780 for a multifamily building 790 (FIG. 35D).

Although the invention has been described in conjunction with specific embodiments thereof, it is evident that many alternatives modifications and variations will be apparent to those skilled in the art. Accordingly, it is intended to embrace all such alternatives, modifications and variations that fall within the spirit and broad scope of the appended claims. All publications, patents and patent applications mentioned in dais specification are herein incorporated in their entirety by reference into the specification to the same extent as if each individual publication, patent or patent application was specifically and individually indicated to be incorporated herein by reference. In addition, citation or identification of any reference in this application shall not be construed as an admission that such reference is available as prior art to the present invention.

What is claimed is:

1. A spout, for face and body treatment, comprising:
a casing, having an inner chamber and a proximal surface, with respect to a portion of the body, for applying a suction treatment to said portion of the body; and
at least one ultrasound transducer, mounted on said proximal surface, for applying an ultrasound treatment to said portion of thc body.

2. The spout of claim 1, and further including a plurality of ultrasound transducers.

3. The spout of claim 1, and further including a gripping handle.

4. The spout of claim 1, connected to a computerized face and body treatment system, and controlled by a computer of said face and body treatment system.

5. The spout of claim 4, detachably connected to said computerized face and body treatment system.

6. The spout of claim 4, and further including at least one control feature, which communicates with said computer.

7. The spout of claim 1, adapted for applying at least one additional mode of treatment, selected from the group consisting of warming light treatment, white-light halogen treatment, fa infrared light treatment, medium infrared light treatment, near infrared light treatment, UV light treatment, Low Level Laser Treatment (LLLT), RF treatment, pulsating magnetic field treatment, constant magnetic field treatment, electrostimulation treatment, cooling-diode treatment, warming-diode treatment, mechanical epilation and photoepilation.

8. A device for face and body treatment, comprising:
at last one ultrasound transducer, mounted on said proximal surface, for applying an ultrasound treatment to said portion of the body; and
at least one additional mode of treatment, selected from the group consisting of warming light treatment, white-light halogen treatment, far infrared light treatment, medium infrared light treatment, near infrared light treatment, UV light treatment, Low Level Laser Treatment (LLLT), RF treatment, pulsating magnetic field treatment, constant magnetic field treatment, electrostimulation treatment, cooling-diode treatment, warming-diode treatment, mechanical epilation and photoepilation.

9. The device of claim 8, and further including a plurality of ultrasound transducers.

10. The device of claim 8, and further including a gripping handle.

11. The device of claim 8, connected to a computerized face and body treatment system, and controlled by a computer of said face and body treatment system.

12. The device of claim 11, detachably connected to said computerized face and body treatment system.

13. The device of claim 11, and further including at least one control feature, which communicates with said computer.

14. A spout, for face and body treatment, comprising:
a casing, having an inner chamber and a proximal surge, with respect to a portion of the body, for applying a suction treatment to said portion of the body; and
at least electromagnet, incorporated within said casing, for applying a magnetic-field treatment to said portion of the body.

15. The spout of claim 14, wherein said magnetic-field treatment is a pulsating magnetic-field treatment.

16. The spout of claim 14, and further including a gripping handle.

17. The spout of claim 14, connected to a computerized face and body treatment system, and controlled by a computer of said face and body treatment system.

18. The spout of claim 17, detachably connected to said computerized face and body treatment system.

19. The spout of claim 17, and further including at least one control feature, which communicates with said computer.

20. The spout of claim 14, adapted for applying at least one additional mode of treatment, selected from the group consisting of warming light treatment, white-light halogen treatment, far infrared light treatment, medium infrared light treatment, near infrared light treatment, UV light treatment, Low Level Laser Treatment (LLLT), RF treatment, ultrasound treatment, electrostimulation treatment, cooling-diode treatment, warming-diode treatment, mechanical epilation and photoepilation.

21. A device, for face and body treatment, comprising:
at least electromagnet, incorporated within said casing, for applying a magnetic-field treatment to said portion of the body; and
at least one additional mode of treatment, selected from the group consisting of warming light treatment, white-light halogen treatment, far infrared light treatment, medium infrared light treatment, near infrared light treatment, UV light treatment, Low Level Laser Treatment (LLLT), RF treatment, ultrasound treatment, electrostimulation treatment, cooling-diode treatment, warming-diode treatment, mechanical epilation and photoepilation.

22. The device of claim 21, wherein said magnetic-field treatment is a pulsating magnetic-field treatment.

23. The device of claim 21, and further including a gripping handle.

24. The device of claim 21, connected to a computerized face and body treatment system, and controlled by a computer of said ace and body treatment system.

25. The device of claim 24, detachably connected to said computerized face and body treatment system.

26. The device of claim 24, and further including at least one control feature, which communicates with said computer.

27. A face-and-body-treatment system, comprising:
a computerized device, for operating said system, said computerized device including:
at least one electrical control feature, for controlling the operation of said system;
a display screen for displaying parameters relating to said treatment; and
a controller, in signal communication with said display screen and said at least one electrical control feature; and
a mirror, integrated with said system, for self-application of face-and-body treatments; and
at least one treatment device.

28. The system of claim 27, and further including a ling device.

29. The system of claim 27, wherein said display screen is interactive.

30. The system of claim 27, wherein said at least one electrical control feature includes a plurality of electrical control features.

31. The system of claim 27, adapted for storing desired operational schedules in a memory.

32. The system of claim 27, adapted for reading desired operational schedules from a memory.

33. The system of claim 27, adapted for maintaining a treatment schedule log, for follow-up of treatment application types, durations, operational parameters, and dates and hours of the applications.

34. The system of claim 27, adapted for maintaining a treatment schedule log, for follow-up of treatment application types, durations, operational parameters, and dates and hours of the applications, for several users, by user ID.

35. The system of claim 27, wherein said at least one treatment device is a suction treatment device, in signal communication with said controller and in fluid communication with a vacuum source, said device having a spout, which defines an inner chamber, and said device being adapted to apply a suction treatment to a portion of the body.

36. The system of claim 35, wherein said vacuum source is a vacuum cleanser.

37. Thc system of claim 35, wherein said vacuum source is a central vacuum line.

38. The system of claim 35, wherein said vacuum source is a dedicated pump.

39. The system of claim 35, wherein said vacuum source is in signal communication with said controller and said vacuum source is adapted to operate at different levels of suction, as controlled by said controller and as selected via said at least one electrical control feature.

40. The system of claim 35, wherein said vacuum source is in signal communication with said controller and said vacuum source is adapted to pulsate at different frequencies, as controlled by said controller and as selected via said at least one electrical control feature.

41. The system of claim 35, wherein said suction treatment device is selected from the group consisting of a device generally for the face, a device for the area around the eyes, a device for the chin, a device for the general body, a device for the breast, a device for the two breasts, and a device for the penis.

42. The system of claim 35, wherein said spout comprises a roller.

43. The system of claim 35, wherein said spout is adapted to glide along a portion of the body and apply suction, macro massage treatment thereto.

44. The system of claim 35, wherein said spout comprises a second mode of treatment, selected from thc group consisting of warming light warming white-light halogen treatment, far infrared light treatment, medium infrared light treatment, near infrared light treatment, UV light treatment, Low Level Laser Treatment (LLLT), RF treatment, ultrasound treatment, pulsating magnetic field treatment, constant magnetic field treatment, electrostimulation treatment, cooling-diode treatment, warming-diode treatment, mechanical epilation, photoepilation, cupping treatment, hair drying, nail drying, oxygen treatment, ozone treatment, and steam treatment.

45. The system of claim 44, adapted for automatically applying a desired operational schedule of said suction massage treatment and said second mode of treatment, each treatment having predetermined operational parameters.

46. The system of claim 45, adapted for automatically applying said desired operational schedule, in a manner selected from the group consisting of in parallel and in series.

47. The system of claim 35, wherein said spout comprises at least two additional modes of treatment, selected from the group consisting of warming light treatment, white-light halogen treatment, far infrared light treatment, medium infrared light treatment, near infrared light treatment, UV light treatment, Low Level Laser Treatment (LLLT), RF treatment, ultrasound treatment, pulsating magnetic field treatment, constant magnetic field treatment, electrostimulation treatment, cooling-diode treatment, warming-diode treatment, mechanical epilation, photoepilation, cupping treatment, hair drying, nail drying, oxygen treatment, ozone treatment, and steam treatment.

48. The system of claim 47, adapted for automatically applying a desired operational schedule of said suction massage treatment and said at least two additional modes of treatment, each reagent having predetermined operational parameters.

49. The system of claim 48, adapted for automatically applying said desired operational schedule, in a manner selected from the group consisting of in parallel and in series.

50. The system of claim 27, wherein said at least one treatment device comprises a plurality of treatment devices, of different shapes and features.

51. The system of claim 50, wherein said plurality of treatment devices are detachable and interchangeable.

52. The system of claim 50, wherein said plurality of treatment devices are adapted for women.

53. The system of claim 50, wherein said plurality of treatment devices are adapted for men.

54. The system of claim 50, wherein said plurality of treatment devices are adapted for both men and women.

55. The system of claim 50, wherein said plurality of treatment devices am adapted for a clinic.

56. The system of claim 27, wherein said at least one treatment device is adapted for at least two modes of treatment.

57. The system of claim 56, adapted for automatically applying a desired operational schedule of said two modes of treatment, each treatment having predetermined operational parameters.

58. The system of claim 57, adapted for automatically applying said desired operational schedule, in a manner selected from the group consisting of in parallel and in series.

59. The system of claim 27 wherein said at least one treatment device is adapted for applying a mode of treatment, selected from the group consisting of suction treatment, suction, macro massage treatment, cupping treatment, warming light treatment, white-light halogen treatment, white-light fluorescent treatment, far infrared light treatment, medium infrared light treatment, near infrared light treatment, UV light treatment, Low Level LAser Treatment (LLLT, RF treatment, ultrasound treatment, pulsating magnetic field treatment, constant magnetic field treatment, electrostimulation treatment, microcurrent treatment, cooling-diode treatment, warming-diode treatment, mechanical epilation, photoepilation, ultrasound epilation, hair drying, electric hair setting, rotating-hair-brush hair rolling, nail drying, oxygen treatment, oxygen peeling ozone treatment, steam treatment, sandblasting peeling, face-and-body-cleaning-moisturizing-and-massaging treatment, lymphatic massage treatment, and air-brush makeup application.

60. The system of claim 27 wherein said at least one treatment device is adapted for applying at least two different modes of treatment, selected from the group consisting of suction treatment, suction, macro massage treatment, cupping treatment, warming light treatment, white-light halogen treatment, white-light fluorescent treatment, far infrared light treatment, medium infrared light treatment, near infrared light treatment, UV light treatment, Low Level Laser Treatment (LLLT), RF treatment, ultrasound treatment, pulsating magnetic field treatment, constant magnetic field treatment, electrostimulation treatment, microcurrent treatment, cooling-diode treatment, warming-diode treatment, mechanical epilation, photoepilation, ultrasound epilation, hair drying, electric hair setting, rotating-hair-brush hair roiling, nail drying, oxygen treatment, oxygen peeling, ozone treatment, steam treatment, sandblasting peeling, face-and-body-cleaning-moisturizing-and-massaging treatment, lymphatic massage treatment, and air-brush makeup application.

61. The system of claim 60, adapted for automatically applying a desired operational schedule of said two modes of treat, each treatment having predetermined operational parameters.

62. The system of claim 61, adapted for automatically applying said desired operational schedule, in a manner selected from the group consisting of in parallel and in series.

63. The system of claim 27, arranged as a portable system.

64. The system of claim 63, arranged as a face-and-body-treatment laptop, wherein:
said mirror is built into a cover of said laptop;
said computerized system is built into said laptop; and
said at least one treatment device is stored within an inner space of said laptop.

65. The system of claim 64, and further including a power source.

66. The system of claim 65, wherein said power source is rechargeable.

67. The system of claim 64, and further including a control panel, for said at least one electrical control feature and said display screen.

68. The system of claim 64, and further including a vacuum pump.

69. The system of claim 64, wherein said at least one treatment device is a suction treatment device, having a suction hose, coiled in a duct within said inner space, and sized so as to exactly fit within said duct.

70. The system of claim 64, and further including a compressor.

71. The system of claim 64, wherein said at least one treatment device comprises at least two treatment devices, stored within an inner space of said laptop.

72. The system of claim 64, wherein said mirror includes a lighting system.

73. The system of claim 64, wherein said mirror includes a magnification portion.

74. The system of claim 64, wherein said system includes a magnification lens, attached to said mirror.

75. The system of claim 64, wherein said mirror includes flaps, for viewing from a side angle.

76. The system of claim 64, wherein said flaps are adjustable for different viewing angles.

77. The system of claim 64, wherein said mirror is removable and detachable, for viewing from different positions and angles.

78. The system of claim 64, wherein said display panel is arranged on said mirror.

79. The system of claim 64, wherein said control panel is arranged along said mirror.

80. The system of claim 64, arranged in a carrying trunk, and further including a pump, arranged within said carrying trunk.

81. The system of claim 64, and further including a compressor, arranged within said carrying trunk.

82. The system of claim 27, built into a dresser.

83. The system of claim 82, and further including a control panel, for said at least one electrical control feature and said display screen.

84. The system of claim 82, and further including a power source.

85. The system of claim 82, and further including a vacuum pump.

86. The system of claim 82, and further including a compressor.

87. The system of claim 82, wherein said at least one treatment device comprises at least two treatment devices, stored within an inner space of said dresser.

88. The system of claim 82, wherein said mirror includes a lighting system.

89. The system of claim 82, wherein said mirror includes a magnification portion.

90. The system of claim 82, wherein said system includes a magnification lens, attached to said mirror.

91. The system of claim 82, wherein said mirror includes flaps, for viewing from a side angle.

92. The system of claim 82, wherein said flaps are adjustable for different viewing angles.

93. The system of claim 82, wherein said mirror is removable and detachable, for viewing from different positions and angles.

94. The system of claim 82, wherein said display panel is arranged on said mirror.

95. The system of claim 82, wherein said control panel is arranged along said mirror.

96. The system of claim 27, built into a chair.

97. The system of claim 96, and further including a control panel, for said at least one electrical control feature and said display screen.

98. The system of claim 96, and further including a power source.

99. The system of claim 96, and further including a vacuum pump.

100. The system of claim 96, and further including a compressor.

101. The system of claim 27, built into a room.

102. The system of claim 101, and further including a control panel, for said at least one electrical control feature and said display screen.

103. The system of claim 101, and further including a pump.

104. The system of claim 101, and further including a compressor.

105. The system of claim 101, wherein said room is a bedroom.

106. The system of claim 101, wherein said room is a bathroom.

107. The system of claim 101, wherein said room is a clinic.

108. A method for face and body treatment, comprising:
automatically applying a first mode of treatment, selected from the group consisting of suction, macro-massage treatment, warming light treatment, infrared light treatment, UV light treatment, LLLT, RF treatment, pulsating magnetic field treatment, constant magnetic field treatment, electrostimulation treatment, cooling-diode treatment, warming-diode treatment, and cooling-warming-diode treatment; and
automatically applying a second mode of treatment, different from said first mode, said second mode of treatment being selected from the group consisting of suction, macro-massage treatment, warming light treatment, infrared light treatment, UV light treatment, LLLT, RF treatment, pulsating magnetic field treatment, constant magnetic field treatment, electrostimulation treatment, cooling-diode treatment, warming-diode treatment, cooling-warming-diode treatment,
wherein said first and second modes of treatment may be selectively applied in tandem, and selectively applied in sequence, in accordance with predetermined restrictions.

109. The method of claim 108, wherein said first and second modes of treatment are applied in accordance with a predetermined schedule.

110. The method of claim 108, wherein said modes of treatment are self-applied.

111. An oxygen treatment device, comprising:
a canister containing a mixture of liquefied oxygen and a carrier;
an oxygen line, to which gaseous oxygen flows out of said canister, and
an applicator, for applying said gaseous oxygen.

112. The oxygen treatment device of claim 111, and further including a regulating valve, for controlling the flow of said gaseous oxygen out of said canister.

113. The oxygen treatment device of claim 111, wherein said applicator is a facial mask.

114. The oxygen treatment device of claim 111, wherein said carrier is an aromatic oil.

115. The oxygen treatment device of claim 111, and further including an airline, in communication with said oxygen line, via a connector, for mixing air with said gaseous oxygen.

116. A lymphatic massaging device, comprising:
a flexible material, formed of a plurality of pockets, arranged abut to each other, each pocket including:
an inlet and a solenoid valve, at said inlet, and
an outlet;
an airline, in communication with each inlet;
a power-and-control cable, in communication with each solenoid valve;
a controller, in communication with said airline and power and control cable, for controlling the air inflow to each pocket, so as to generate a pressure wave through said flexible material.

117. The massage device of claim 116, arranged as a soft hose, and further including a vacuum source, for creating a vacuum within a lumen defined by said soft hose, for operation as an erection device.

118. A cupping system, comprising
a plurality of cups; and
at least one vacuum hose, in communication with said cups, and in communication with a vacuum source, for providing a vacuum to said cups.

119. The cupping system of claim 95, and further including a regulating system, for controlling the vacuum within said cups.

120. A face-and-body-treatment, laptop-like kit, comprising:
a computerized device, built into said laptop-like kit; and
a mirror, built into a cover portion of said laptop-like kit, for self-application of face and-body treatments; and
at least one treatment device, stored within an inner space of said laptop-like kit.

121. The system of claim 120, and further including a power source.

122. The system of claim 121, wherein said power source is rechargeable.

123. The system of claim 120, and further including a control panel, for said at least one electrical control feature and said display screen.

124. The system of claim 120, and further including a vacuum pump.

125. The system of claim 120, wherein said at least one treatment device is a suction treatment device, having a suction hose, coiled in a duct within said inner space, and sized so as to exactly fit within said duct.

126. The system of claim 120, and further including a compressor.

127. The system of claim 120, wherein said at least one treatment device comprises at least two treatment devices, stored within an inner space of said laptop.

128. The system of claim 120, wherein said mirror includes a lighting system.

129. The system of claim 120, wherein said mirror includes a magnification portion.

130. The system of claim 120, wherein said system includes a magnification lens, attached to said minor.

131. The system of claim 120, wherein said mirror includes flaps, for viewing from a side angle.

132. The system of claim 120, wherein said flaps are adjustable for different viewing angles.

133. The system of claim 120, wherein said mirror is removable and detachable, for viewing from different positions and angles.

134. The system of claim 120, wherein said display panel is arranged on said mirror.

135. The system of claim 120, wherein said control panel is arranged along said mirror.

136. The system of claim 120, arranged in a crying trunk, and further including a pump, arranged within said carrying trunk.

137. The system of claim 120, and further including a compressor, arranged within said carrying trunk.

138. The system of claim 120 wherein said at least one treatment device is adapted for applying a mode of treatment, selected from the group consisting of suction treatment, suction, macro massage treatment, cupping treatment, warming light treatment, white-light halogen treatment, white-light fluorescent treatment, far infrared light treatment, medium infrared light treatment, near infrared light treatment, UV light treatment, Low Level Laser Treatment (LLLT), RF treatment, ultrasound treatment, pulsating magnetic field treatment, constant magnetic field treatment, electrostimulation treatment, microcurrent treatment, cooling-diode treatment, warming-diode treatment, mechanical epilation, photoepilation, ultrasound epilation, hair drying, electric hair setting, rotating-hair-brush hair rolling, nail drying, oxygen treatment, oxygen peeling, ozone treatment steam treatment, sandblasting peeling, face-and-body-cleaning-moisturizing-and-massaging treatment, lymphatic massage treatment, and air-brush makeup application.

139. The system of claim 120 wherein said at least one treatment device is adapted for applying at least two different modes of tent, selected from the group consisting of suction treatment, suction, macro massage treatment, cupping treatment, warming light treatment, white-light halogen treatment, white-light fluorescent treatment, far light treatment, medium infrared light treatment, near infrared light treatment, UV light treatment, Low Level Laser Treatment (LLLT), RF treatment, ultrasound treatment, pulsating magnetic field treatment, constant magnetic field treatment, electrostimulation treatment, microcurrent treatment, cooling-diode treatment, warming-diode treatment, mechanical epilation, photoepilation, ultrasound epilation, hair drying, electric hair setting, rotating-hair-brush hair rolling, nail drying, oxygen treatment, oxygen peeling, ozone treatment, steam treatment, sandblasting peeling, face-and-body-cleaning-moisturizing-and-massaging treatment, lymphatic massage treatment, and air-brush makeup application.

140. A face-and-body-treatment system, built into a dresser, comprising:
a computerized device, built into said dresser,
a mirror, built onto said dresser, for self-application of face-and-body treatments; and
at least one treatment device, stored within said dresser.

141. The system of claim 140, and further including a control panel, for said at least one electrical control feature and said display screen.

142. The system of claim 140, and further including a power source.

143. The system of claim 140, and further including a vacuum pump.

144. The system of claim 140, and further including a compressor.

145. The system of claim 140, wherein said at least one treatment device comprises at least two treatment devices, stored within an inner space of said dresser.

146. The system of claim 140, wherein said mirror includes a lighting system.

147. The system of claim 140, wherein said mirror includes a magnification portion.

148. The system of claim 140, wherein said system includes a magnification lens, attached to said mirror.

149. The system of claim 140, wherein said mirror includes flaps, for viewing from a side angle.

150. The system of claim 140, wherein said flaps are adjustable for different viewing angles.

151. The system of claim 140, wherein said mirror is removable and detachable, for viewing from different positions and angles.

152. The system of claim 140, wherein said display panel is arranged on said mirror.

153. The system of claim 140, wherein said control panel is arranged along said mirror.

154. The system of claim 140 wherein said at least one treatment device is adapted for applying a mode of treatment, selected from the group consisting of suction treatment, suction, macro massage treatment, cupping treatment, warming light treatment, white-light halogen treatment, white-light fluorescent treatment, far infrared light treatment, medium infrared light treatment, net infrared light treatment, UV light treatment, Low Level Laser Treatment (LLLT, RF treatment, ultrasound treatment, pulsating magnetic field treatment, constant magnetic field treatment, electrostimulation treatment, microcurrent treatment, cooling diode treatment, warming-diode treatment, mechanical epilation, photoepilation, ultrasound epilation, hair ding, electric hair setting, rotating-hair-brush hair rolling, nail drying, oxygen treatment, oxygen peeling, ozone treatment, steam treatment, sandblasting peeling, face-and-body-cleaning-moisturizing-and-massaging treatment, lymphatic massage treatment, and air-brush makeup application.

155. The system of claim 27 wherein said at least one treatment device is adapted for applying at least two different modes of treatment, selected from the group consisting of suction treatment, suction, macro massage treatment, cupping treatment, warming light treatment, white-light halogen treatment, white-light fluorescent treatment, far infrared light treatment, medium infrared light treatment, near infrared light treatment, UV light treatment, Low Level Laser Treatment (LLLT), RF treatment, ultrasound treatment, pulsating magnetic field treatment, constant magnetic field treatment, electrostimulation treatment, microcurrent treatment, cooling-diode treatment, warming-diode treatment, mechanical epilation, photoepilation, ultrasound epilation, hair drying, electric hair setting, rotating-hair-brush hair rolling, nail drying, oxygen treatment, oxygen peeling ozone treatment, steam treatment, sandblasting peeling, face-and-body-cleaning-moisturizing-and-massaging treatment, lymphatic massage treatment, and air-brush makeup application.
